(19) United States
(12) Patent Application Publication
(10) Pub. No.: US 2026/0195330 A1
(43) Pub. Date: Jul. 9, 2026

(54) INFORMATION PROCESSING SYSTEM, TERMINAL, INFORMATION PROCESSING METHOD, PROGRAM, AND DATA STRUCTURE

(71) Applicant: Datascientist Inc., Tokyo (JP)

(72) Inventors: Yuki HIROBE, Tokyo (JP); Naoya SAKAKIBARA, Tokyo (JP)

(73) Assignee: Datascientist Inc., Tokyo (JP)

(21) Appl. No.: 18/875,466

(22) PCT Filed: Aug. 5, 2022
(86) PCT No.: PCT/JP2022/030036

§ 371 Date: Sep. 10, 2025

(51) Int. Cl. G06F 16/2457; G06F 16/9535; G06F 16/9538

(52) U.S. Cl. CPC G06F 16/24578; G06F 16/9535; G06F 16/9538

(57) ABSTRACT

A terminal and a computer system are provided, and in a case where a target search query of web content is received from a user, the terminal or the computer system outputs information for displaying a plurality of sub-search words/phrases used for search together with the target search query in another search query and/or a plurality of contained words/phrases mentioned on web pages up to a predetermined rank in search results of the target search query as a word/phrase list in a tree structure, and outputs information for displaying a combination of a heading tag assigned according to a hierarchy of each node of the tree structure and a word/phase of the node when a specific operation is executed by the user on a part or all of the displayed tree structure.

### TECHNICAL FIELD

The present invention relates to an information processing system, a terminal, an information processing method, a program, and a data structure.

### BACKGROUND ART

In recent years, search engines have begun to analyze text data of web pages and assign search rankings thereto. As a technology aimed at displaying web pages at the top of search results, for example, Patent Literature 1 discloses that first processing of performing morphological analysis processing on content of an element of web page data of an analysis target web page acquired by a web page acquisition means for each of a predetermined number of analysis target web pages, second processing of aggregating a containing number of each morpheme of the same type in a morpheme group obtained by the first processing, and third processing of obtaining an evaluation value for each morpheme indicating a degree of contribution of each morpheme to a rank of the analysis target page in a search result of search using a target keyword as a search query by causing the containing number of each morpheme in the analysis target web page obtained by the second processing to act on a predetermined evaluation function are executed, and a list in which evaluation values for each morpheme obtained for a predetermined number of analysis target web pages are arranged for each analysis target web page is presented as an analysis result.

### CITATION LIST

### Patent Literature

Patent Literature 1: Japanese Patent No. 6,164,436

Patent Literature 2: Japanese Patent No. 6,253,041

### SUMMARY OF INVENTION

### Technical Problem

An information processing system according to a first aspect of the invention includes a terminal and a computer system,
wherein, in a case where a target search query of web content is received from a user, the terminal or the computer system outputs information for displaying a plurality of sub-search words/phrases used for search together with the target search query in another search query and/or a plurality of contained words/phrases mentioned on web pages up to a predetermined rank in search results of the target search query as a word/phrase list in a tree structure, and
wherein the terminal or the computer system outputs information for displaying a combination of a heading tag assigned according to a hierarchy of each node of the tree structure and a word/phase of the node when a specific operation is executed by the user on a part or all of the displayed tree structure.

An information processing system according to a second aspect of the invention is the information processing system according to the first aspect, wherein the terminal or the computer system outputs information for displaying a list of the sub-search words/phrases or a list of the contained words/phrases according to an operation of the user, and
wherein the terminal performs control to add a selected word/phrase to the word/phrase list in accordance with operations of the user to select a word/phrase in the list of the sub-search words/phrases or a word/phrase in the list of the contained words/phrases and to add the selected word/phrase to a target segment.

An information processing system according to a third aspect of the invention is the information processing system according to the second aspect, wherein the terminal or the computer system outputs information for displaying a list obtained by sorting the sub-search words/phrases by segments of the sub-search words/phrases, a number of types of search queries including the target search query and the sub-search words/phrases, total numbers of searches or economic scales of search queries including the target search query and the sub-search words/phrases, industry uniqueness of the sub-search words/phrases, generalities of the sub-search words/phrases, a number of web pages in which the sub-search words/phrases appear among top search web pages, or frequencies at which the sub-search words/phrases appear in the top search web pages according to a sorting operation of the user on the list of the sub-search words/phrases.

An information processing system according to a fourth aspect of the invention is the information processing system according to the second aspect, wherein the terminal or the computer system outputs information for displaying a list in which the contained words/phrases are sorted by industry uniqueness of the contained words/phrases, generalities of the contained words/phrases, frequencies at which the contained words/phrases are emphasized, and frequencies at which the contained words/phrases appear on a web page of a specific search rank, according to a sorting operation of the user on the list of the contained words/phrases.

An information processing system according to a fifth aspect of the invention is the information processing system according to any one of the first to fourth aspect, wherein the terminal or the computer system updates the tree structure such that another second word/phrase is added to a child node of a first word/phrase in response to a user operation of adding another second word/phrase to a layer lower than the first word/phrase on a display screen on which a plurality of words/phrases including the first word/phrase and the second word/phrase is displayed.

An information processing system according to a sixth aspect of the invention is the information processing system according to any one of the first to fifth aspect, wherein, when the user selects one parameter from among the number of web pages in which a target word/phrase appears among top search web pages, a content degree of the target word/phrase in the top search web pages, a uniqueness of the target word/phrase, and a total search number or an economic scale of search queries including the target search query and the target word/phrase, the terminal or the computer system performs display control on each word/phrase in the word/phrase list in a display aspect in which a level or an actual number of parameters selected by the user is recognizable.

An information processing system according to a seventh aspect of the invention is the information processing system according to any one of the first to sixth aspect which further includes at least one storage in which a segment representing a category of a word/phrase is stored in association with each word/phrase,
wherein, upon receiving a target search query of web content from the user, the terminal or the computer system outputs information for displaying the plurality of sub-search words/phrases and/or the plurality of contained words/phrases as a word/phrase list for each segment with reference to the storage.

An information processing system according to a eighth aspect of the invention includes at least one processor configured to,
in a case where a target search query of web content is received from a user, output information for displaying a plurality of sub-search words/phrases used for search together with the target search query in another search query, and search linking words/phrases including the target search query and the sub-search words/phrases such that the search linking words/phrases are associated with the sub-search words/phrases.

An information processing system according to a ninth aspect of the invention includes at least one processor, wherein
in a case where a target search query of web content is received from a user, the at least one processor causes a plurality of sub-search words/phrases used for search together with the target search query in another search query and/or a plurality of contained words/phrases mentioned on web pages up to a predetermined rank in search results of the target search query to be displayed as a word/phrase list in a tree structure, and
outputs information for displaying a combination of a heading tag assigned according to a hierarchy of each node of the tree structure and a word/phrase of the node when a specific operation by the user is executed on a part or all of the displayed tree structure.

An information processing method according to tenth aspect includes:
a procedure of outputting, in a case where a target search query of web content is received from a user, information for displaying a plurality of sub-search words/phrases used for search together with the target search query in another search query and/or a plurality of contained words/phrases mentioned on web pages up to a predetermined rank in search results of the target search query as a word/phrase list in a tree structure; and
a procedure of outputting information for displaying a combination of a heading tag assigned according to a hierarchy of each node of the tree structure and a word/phrase of the node when a specific operation by the user is executed on a part or all of the displayed tree structure.

An information processing method according to eleventh aspect includes:
a procedure in which, in a case where a target search query of web content is received from a user, at least one processor displays a plurality of sub-search words/phrases used for search together with the target search query in another search query and/or a plurality of contained words/phrases mentioned on web pages up to a predetermined rank in search results of the target search query as a word/phrase list in a tree structure, and
a procedure in which the processor outputs information for displaying a combination of a heading tag assigned according to a hierarchy of each node of the tree structure and a word/phase of the node when a specific operation is executed by the user on a part or all of the displayed tree structure.

An information processing method according to tenth aspect includes:
a procedure of outputting, in a case where a target search query of web content is received from a user, information for displaying a word/phrase list obtained by visualizing a plurality of sub-search words/phrases used for search together with the target search query in another search query, and search linking words/phrases including the target search query and the sub-search words/phrases such that the search linking words/phrases are associated with the sub-search words/phrases.

A program according to thirteenth aspect of the invention causes a computer to execute:
a procedure of, in a case where a target search query of web content is received from a user, displaying a plurality of sub-search words/phrases used for search together with the target search query in another search query and/or a plurality of contained words/phrases mentioned on web pages up to a predetermined rank in search results of the target search query as a word/phrase list in a tree structure; and
a procedure of outputting information for displaying a combination of a heading tag assigned according to a hierarchy of each node of the tree structure and a word/phase of the node when a specific operation is executed by the user on a part or all of the displayed tree structure.

A program according to thirteenth aspect of the invention causes a computer to execute a procedure of
outputting, in a case where a target search query of web content is received from a user, information for displaying a word/phrase list obtained by visualizing a plurality of sub-search words/phrases used for search together with the target search query in another search query, and search linking words/phrases including the target search query and the sub-search words/phrases such that the search linking words/phrases are associated with the sub-search words/phrases.

A data structure according to a fifteenth aspect has a tree structure used when a terminal comprising a processor displays a plurality of words/phrases in a tree structure,
wherein the data structure has a word/phrase in association with a root node and has a word/phrase in association with each of at least one or more first child nodes associated with the root node, and the first child node is able to further have at least one or more second child nodes and have a word/phrase in association with each of the second child nodes, and
wherein the processor is caused to read the data structure to display words/phrases in the data structure in a tree structure.

A data structure according to sixteenth aspect used when a terminal comprising a processor displays and/or holds a heading tag of a heading of a web page and a word/phrase in the heading,
wherein the data structure has a word/phrase associated with a heading tag, and
wherein the processor reads the data structure to display a combination of a heading tag and a word/phrase in the data structure.

### Advantageous Effects of Invention

According to one aspect of the present invention, a plurality of sub-search words/phrases used for search together with a target search query in another search query and/or a plurality of contained words/phrases in web pages up to a predetermined rank in a search result of the target search query are displayed, and a web page creator can create a web page using these words/phrases, and thus it is possible to reduce the effort required to create a web page.

According to another aspect of the present invention, a user creates a tree structure for words/phrases having search need, and words/phrases are displayed (for example, in an editable manner) in a state in which a heading tag is assigned according to a hierarchy of the tree structure simply by performing a specific operation (for example, drag and drop) on the tree structure by the user, and thus it is possible to reduce the effort required to create a web page by creating a web page using the tree structure.

### BRIEF DESCRIPTION OF DRAWINGS

FIG. 1 is a schematic configuration diagram of an information processing system according to the present embodiment.

FIG. 2 is a schematic configuration diagram of a terminal according to the present embodiment.

FIG. 3 is a schematic configuration diagram of a computer system according to the present embodiment.

FIG. 4 is an example of a word/phrase dictionary table stored in advance in a storage 23.

FIG. 5 is a schematic diagram of a target search query input screen.

FIG. 6 is a schematic diagram of a display screen.

FIG. 7 is a flowchart illustrating an example of a flow of processing according to FIG. 5 and FIG. 6.

FIG. 8 is a schematic diagram illustrating a flow of editing a tree structure of words/phrases.

FIG. 9 is a schematic diagram continuing from FIG. 8.

FIG. 10A is a schematic diagram illustrating an example of a display aspect of a tree structure of words/phrases.

FIG. 10B is an example of a data structure in the case of the tree structure of FIG. 10A.

FIG. 11A is an example of a display screen after a target search query is input.

FIG. 11B is an example of a data structure for displaying and/or holding data of a region R12 in FIG. 11A.

FIG. 12 is an example of a display screen in a case where a sub-search word/phrase list button is pressed.

FIG. 13 is a schematic diagram illustrating a process of adding a sub-search word/phrase from a sub-search word/phrase list to a word/phrase list to be edited.

FIG. 14 is an example of a sub-search word/phrase list table stored in the storage 23 in a processing process.

FIG. 15 is a flowchart illustrating an example of a flow of processing of adding a sub-search word/phrase from a sub-search word/phrase list to a tree structure.

FIG. 16 is an example of a display screen in a case where a contained word/phrase list button is pressed.

FIG. 17 is a schematic diagram illustrating a process of adding a word/phrase from a contained word/phrase list to a word/phrase list to be edited.

FIG. 18 is an example of a contained word/phrase list table stored in the storage 23 in a processing process.

FIG. 19 is an example of a screen containing examples of a word/phrase selected by a user.

FIG. 20 is an example of an example list table T4 of the storage 23.

FIG. 21 is a flowchart illustrating an example of a flow of processing of adding a contained word/phrase from a contained word/phrase list to a target word/phrase list.

FIG. 22 is a schematic diagram illustrating an example of a display aspect of additional information for each word/phrase in a word/phrase list.

FIG. 23 is a continuation of FIG. 22.

FIG. 24 is a schematic diagram illustrating a flow of highlight setting.

FIG. 25 is a schematic diagram of heat map display obtained by extending the highlight setting of FIG. 24.

FIG. 26 is an example of a schematic diagram of a display screen according to a second embodiment.

### DESCRIPTION OF EMBODIMENTS

Hereinafter, each embodiment will be described with reference to the drawings. However, unnecessarily detailed description may be omitted. For example, a detailed description of well-known matters and redundant description of substantially the same configuration may be omitted. This is to avoid unnecessary redundancy of the following description and to facilitate understanding of those skilled in the art.

### First Embodiment

According to the invention of Patent Literature 1, it is possible to extract important morphemes that may contribute to the search ranking. However, there is still a problem that it takes effort to create web page content (specifically, for example, creation of content such as a table of contents, text, and options of a web page).

An aspect of the present embodiment has been made in view of the above problems, and an object thereof is to provide an information processing system, a terminal, an information processing method, a program, and a data structure capable of reducing the effort required to create a web page.

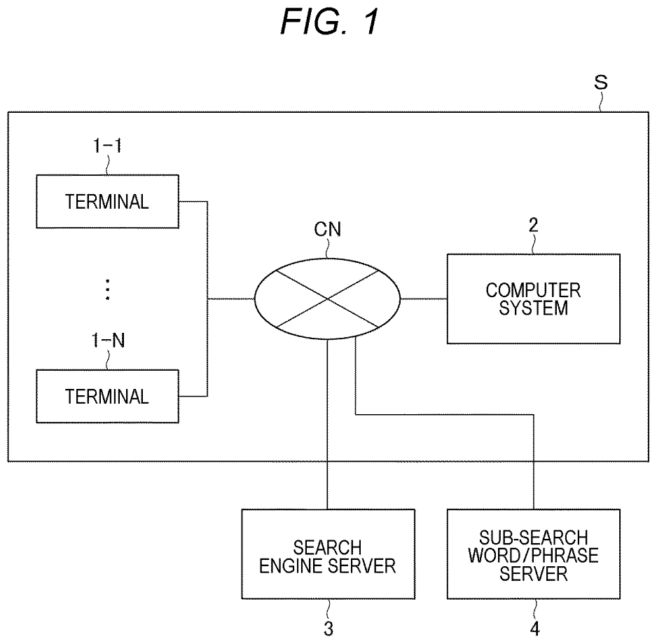

FIG. 1 is a schematic configuration diagram of an information processing system according to the present embodiment. As illustrated in FIG. 1, the information processing system S includes terminals 1-1 to 1-N (N is a natural number) and a computer system 2 connected to the terminals 1-1 to 1-N via a communication circuit network CN. A search engine server 3, which is an example of a search engine, is connected to the computer system 2 via the communication circuit network CN such that they can communicate each other. Further, a sub-search word/phrase server 4 is connected to the computer system 2 via the communication circuit network CN such that they can communicate each other. In the present embodiment, as an example, the information processing system S is described as not including the search engine server 3 and the sub-search word/phrase server 4, but the information processing system S may include the search engine server 3 and/or the sub-search word/phrase server 4.

The terminals 1-1 to 1-N are used by different users, and are, for example, mobile phones such as multifunctional mobile phones (so-called smartphones), tablets, laptop computers, desktop computers, or the like. In the present embodiment, an example in which the terminals 1-1 to 1-N display information transmitted from the computer system 2 via, for example, a web browser, will be described below. Hereinafter, the terminals 1-1 to 1-N are also collectively referred to as a terminal 1.

When the search engine server 3 receives a search query from the computer system 2 via the communication circuit network CN, the search engine server 3 returns a search result of the search query to the computer system 2 via the communication circuit network CN.

When the sub-search word/phrase server 4 receives a target search query from the computer system 2 via the communication circuit network CN, the sub-search word/phrase server 4 returns a list of sub-search words/phrases (hereinafter, also referred to as a sub-search word/phrase list) to be used together with the target search query in another search query to the computer system 2 via the communication circuit network CN.

Here, the target search query is a word that is desired to be hit in the search for target web content, a new word or a phrase (for example, “headache”, “I want to succeed”, or the like) in which a plurality of words are combined. Here, web content contains not only a web page of one page but also a web page group divided into a plurality of web pages in consideration of readability and the like, and a web page group divided into a plurality of web pages such as one, two, and three webpages like serial articles.

An example of one word is “cosmetics”, and an example of a new word is “cosmetics recommendation” in which “cosmetics” and “recommendation” are combined. Here, the word is a word containing one or a plurality of morphemes, and the word includes not only “makeup” but also “cosmetics”, for example.

In addition, a sub-search word/phrase is one word or a new word or a phrase in which a plurality of words are combined.

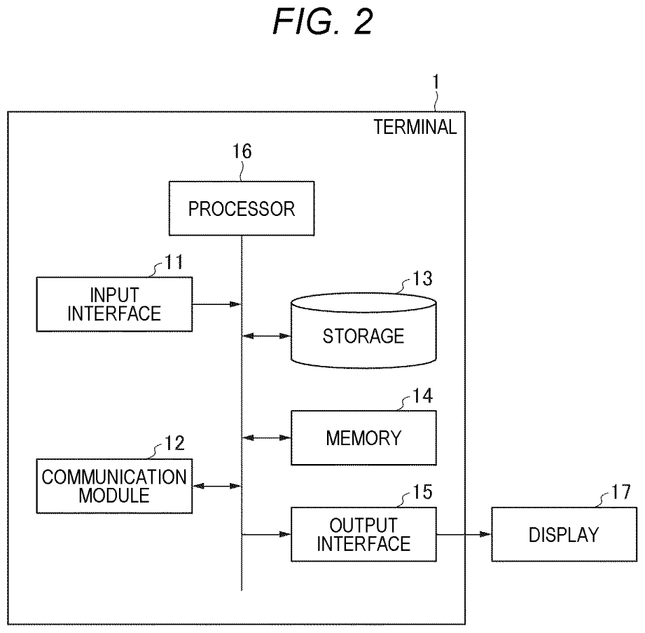

FIG. 2 is a schematic configuration diagram of a terminal according to the present embodiment. As illustrated in FIG. 2, the terminal 1 includes, for example, an input interface 11, a communication module 12, a storage 13, a memory 14, an output interface 15, and a processor 16.

The input interface 11 receives an input from a user and outputs an input signal corresponding to the received input to the processor 16.

The communication module 12 is connected to the communication circuit network CN and communicates with the computer system 2. This communication may be wired or wireless, but will be described as being wireless.

The storage 13 stores programs and various types of data to be read and executed by the processor 16.

The memory 14 temporarily holds data and programs. The memory 14 is a volatile memory and is, for example, a random-access memory (RAM).

The output interface 15 is connected to the display 17 and outputs a video signal to the display 17 according to a command from the processor 16.

The processor 16 loads a program from the storage 13 into the memory 14 and executes a series of instructions included in the program to execute processing.

The display 17 displays information in accordance with a command from the processor 16. The display 17 may be not only externally connected to the terminal 1 but also built into the terminal 1.

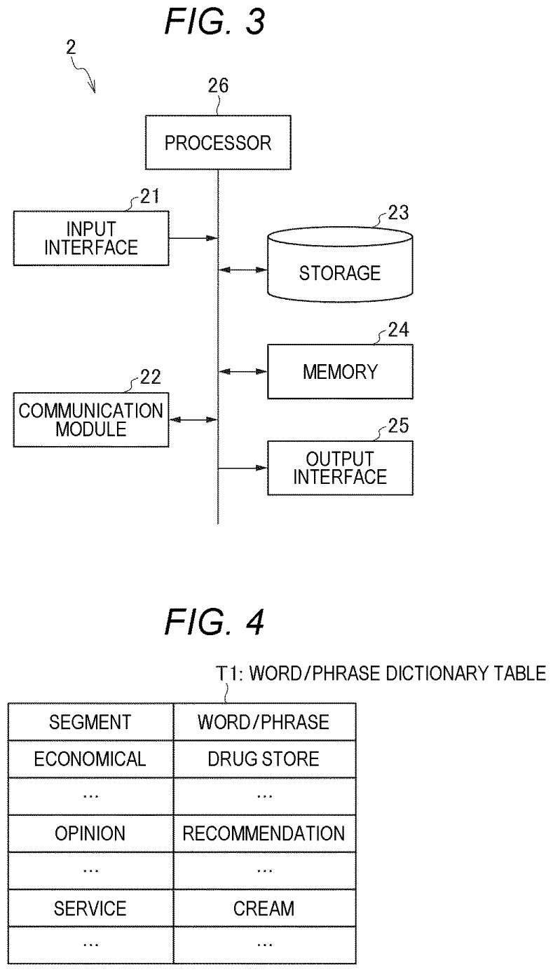

FIG. 3 is a schematic configuration diagram of a computer system according to the present embodiment. As illustrated in FIG. 3, the computer system 2 includes an input interface 21, a communication module 22, a storage 23, a memory 24, an output interface 25, and a processor 26.

The input interface 21 receives an input from an administrator (for example, an employee of a management organization) of the computer system 2 and outputs an input signal corresponding to the received input to the processor 26.

The communication module 22 is connected to the communication circuit network CN and communicates with the terminals 1-1 to 1-N. This communication may be wired or wireless, but will be described as being wired.

The storage 23 stores programs and various types of data to be read and executed by the processor 26.

The memory 24 temporarily holds data and programs. The memory 24 is a volatile memory, and is, for example, a random-access memory (RAM).

The output interface 25 can be connected to an external device and can output a signal to the external device.

The processor 26 loads a program from the storage 23 into the memory 24 and executes a series of instructions included in the program to execute various types of processing.

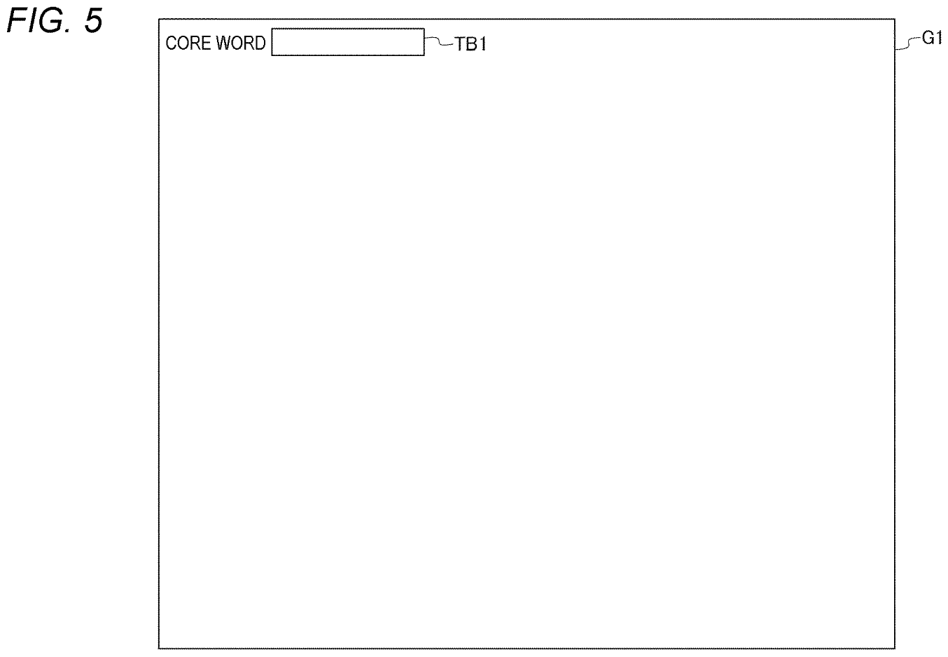

FIG. 4 is an example of a word/phrase dictionary table stored in advance in the storage 23. As illustrated in FIG. 4, in the word/phrase dictionary table T1, a record of a set of a segment representing a word/phrase category and a word/phrase is accumulated in the storage 23. Accordingly, the processor 26 can assign a segment to a target word/phrase by referring to the word/phrase dictionary table T1. Here, a phrase is one word or a new word or a phrase in which a plurality of words are combined, an example of a word is “cosmetics”, and an example of a new word is “cosmetics recommendation” in which “cosmetics” and “recommendation” are connected.

### Screen Transition Example

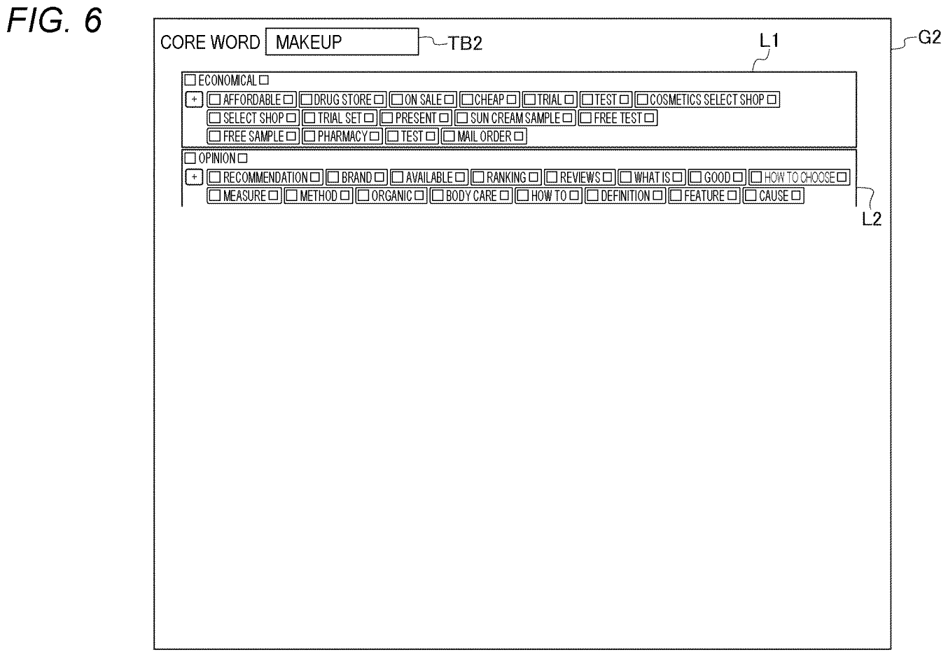

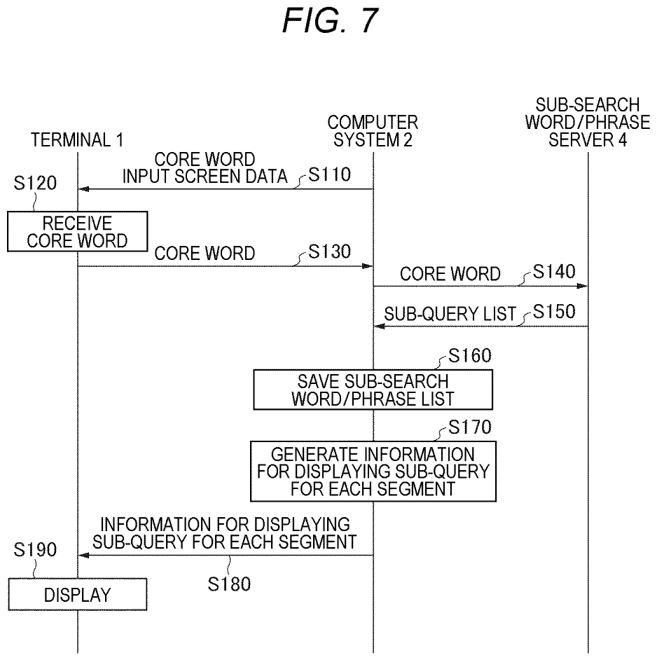

Next, an example of a part of screen transition will be described with reference to FIG. 5 and FIG. 6. FIG. 5 is a schematic diagram of a target search query input screen. As illustrated in FIG. 5, the target search query input screen Gl is provided with a text box TB1 for inputting a target search query used in a search query. When the target search query is input to the text box TB1, transition to a display screen of FIG. 6 occurs. FIG. 6 is a schematic diagram of a display screen. As illustrated in FIG. 6, a text box TB2 to which the target search query is input is displayed on the display screen G2. In addition, in FIG. 6, among sub-search words/phrases used in the search query together with the target search query, sub-search words/phrases included in a segment of “economical” are arranged in a word/phrase list L1. Further, in FIG. 6, among the sub-search words/phrases used in the search query together with the target search query, sub-search words/phrases included in a segment of “opinion” are arranged in a word/phrase list L2.

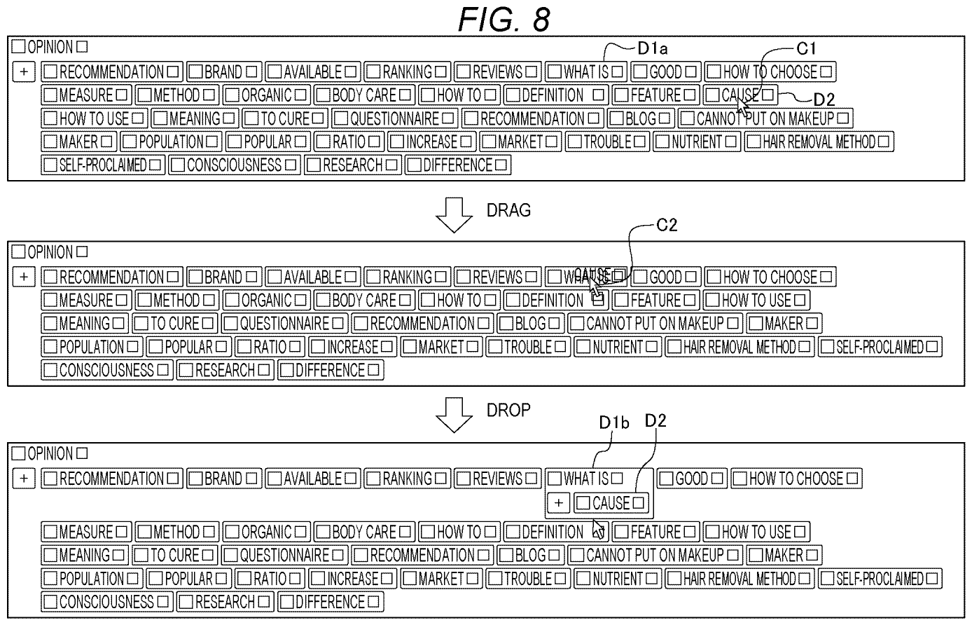

Next, a flow of processing related to screen transition of FIG. 5 and FIG. 6 will be described with reference to FIG. 7. FIG. 7 is a flowchart illustrating an example of a flow of processing according to FIG. 5 and FIG. 6. In the following flowcharts, processing is performed by the processor of the terminal 1, the computer system 2, or the sub-search word/phrase server 4, but description of the processor is omitted because of redundancy.

(Step S110) The computer system 2 transmits target search query input screen data to the terminal 1. Upon receiving the target search query input screen data, the terminal 1 displays the target search query input screen G1 of FIG. 5 using the target search query input screen data.

(Step S120) Next, the terminal 1 receives a target search query of target web content through the target search query input screen G1.

(Step S130) Next, the terminal 1 transmits the received target search query to the computer system 2.

(Step S140) Upon receiving the target search query, the computer system 2 transmits the target search query to the sub-search word/phrase server 4. When the sub-search word/phrase server 4 receives the target search query, the sub-search word/phrase server 4 returns a list of sub-search words/phrases (sub-search word/phrase list) used together with the target search query in another search query to the computer system 2.

(Step S150) Upon receiving the sub-search word/phrase list, the computer system 2 stores the sub-search word/phrase list in the storage 23.

(Step S160) Then, the computer system 2 refers to the word/phrase dictionary table T1 (refer to FIG. 4) of the storage 23 for each sub-search word/phrase included in the received sub-search word/phrase list and generates information for displaying sub-search words/phrases for each segment.

(Step S170) The computer system 2 transmits the information to the terminal 1 in order to display sub-search words/phrases for each segment.

(Step S180) Upon receiving the information for displaying the sub-search words/phrases for each segment, the terminal 1 displays the display screen of FIG. 6 using the information.

As described above, according to one aspect, when the processor 26 receives a target search query of target web content from the user, the processor 26 refers to the storage 23 and outputs information for displaying, for each segment, a plurality of sub-search words/phrases used for search together with the target search query in another search query. Here, the target web content is, for example, web content to be created by the user.

As a result, a plurality of sub-search words/phrases used for search together with the target search query in another search query is displayed for each segment. Sub-search words/phrases in another search query tend to include search needs that supplement the search needs of the search query. For example, in a case where there are other search queries such as “cause of sensitive skin” and “what is sensitive skin” with respect to a target search query such as “sensitive skin”, it is expected that search needs of a searcher who searches for “sensitive skin” will tend to include a search need to seek an explanation of the cause or a search need to seek an explanation of the definition. Therefore, it is considered that it is useful to use information of sub-search words/phrases in describing information required by the searcher. As a result, since a web page creator can create a web page using such sub-search words/phrases, it is possible to reduce the effort to create a web page and create a web page such that it contains information desired by a searcher.

Although the sub-search words/phrases are displayed in FIG. 6, the present invention is not limited thereto, and a plurality of contained words/phrases of web pages up to a predetermined rank in a search result of the target search query may be used. Here, a contained word/phrase is one word, or a new word or a phrase in which a plurality of words are combined. In general, search results obtained by the search engine are displayed in such a manner that a page that the searcher tends to seek is displayed at the top. That is, words/phrases contained in the top page of search results of the corresponding search query tend to contain many words/phrases constituting a sentence matching search needs. Accordingly, it is conceived that it is useful to consider a sentence matching search needs on the basis of the contained words/phrases of the top page. As a result, since a web page creator can create a web page using such sub-search words/phrases, it is possible to reduce the effort to create a web page and create a web page such that it contains information desired by a searcher. In this case, the processor 26 may output information for displaying a plurality of contained words/phrases of web pages up to a predetermined rank in search results of a target search query for each segment in addition to or in place of a plurality of sub-search words/phrases used for search together with the target search query in another search query.

Although displaying a plurality of sub-search words/phrases or a plurality of contained words/phrases for each segment has been described, the present invention is not limited to displaying for each segment, and a plurality of sub-search words/phrases may be simply displayed, or a plurality of sub-search words/phrases may be displayed in a tree structure according to an operation by a user.

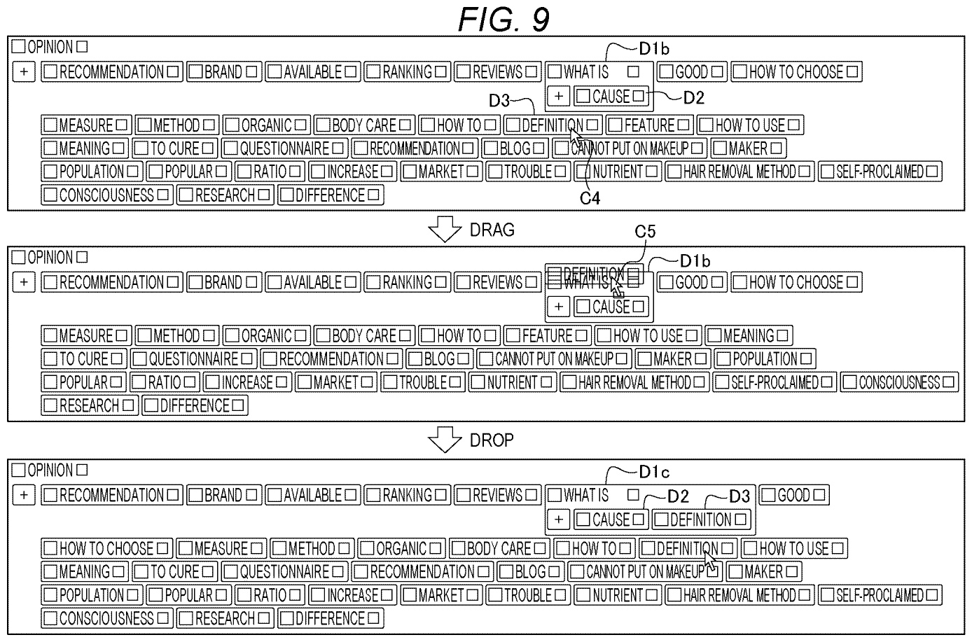

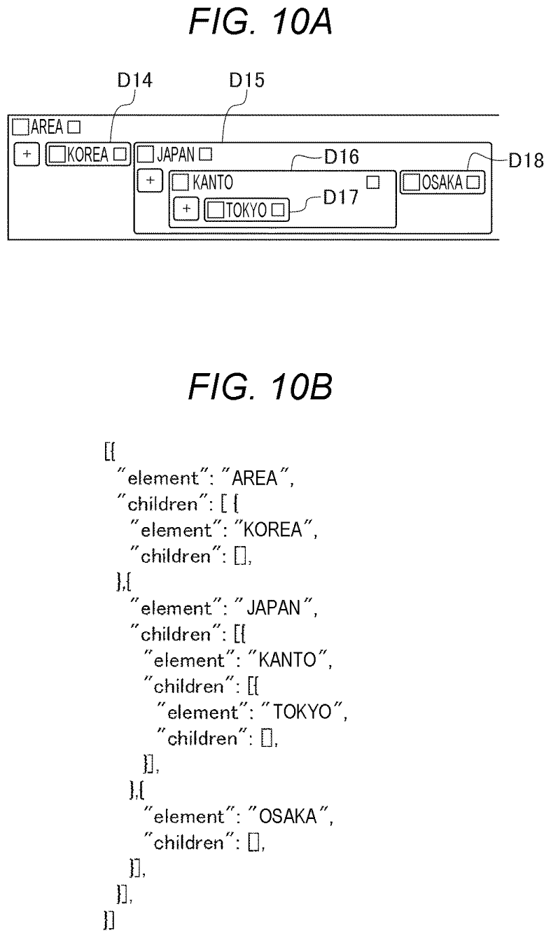

FIG. 8 is a schematic diagram illustrating a flow of editing a tree structure of words/phrases. FIG. 9 is a schematic diagram continuing from FIG. 8. As illustrated in FIG. 8, a segment of “opinion” contains a word/phrase D1a of “what is” and a word/phrase D2 of “cause”. When a cursor C1 is placed on the word/phrase D2 of “cause” and dragged and a cursor C2 is brought over the word/phrase D1a of “what is” and dropped, the word/phrase D2 of “cause” is added to a child node of the word/phrase D1b of “what is”.

Further, as illustrated in FIG. 9, a child node of a word/phrase D1b of “what is” contains a word/phrase D2 of “cause”. When a cursor C4 is placed on a word/phrase D3 of “definition” and dragged and a cursor C5 is brought over the word/phrase D1b of “what is” and dropped, the word/phrase D3 of “definition” is added to a child node of the word/phrase D1c of “what is” in addition to the word/phrase D2 of “cause”. Here, a word/phrase is not limited to one word, and may be a new word in which a plurality of words are combined. As described above, an example of a word is “cosmetics” and an example of a new word is “cosmetics recommendation” in which “cosmetics” and “recommendation” are connected.

In the processes of FIG. 8 and FIG. 9, the processor 16 of the terminal 1 updates the tree structure such that another word/phrase is added to a child node of the word/phrase in response to a user operation of adding another word/phrase to a lower layer of the word/phrase on a display screen on which a plurality of words/phrases containing sub-search words/phrases and/or contained words/phrases are displayed (for example, for each segment). Here, the word/phrase is one word, or a new word or a phrase in which a plurality of words are combined. This processing is realized, for example, by the processor 16 executing JavaScript which is an example of code (client-side script), and in this process, data of the tree structure may be held in the memory 14 of the terminal 1 as variables of JavaScript.

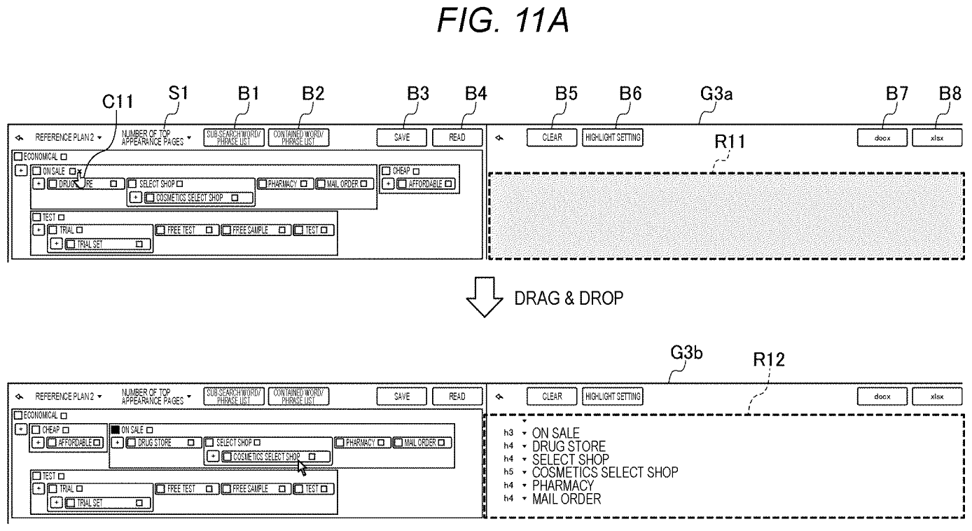

Here, an example of a data structure of a tree structure will be described using FIG. 10A and FIG. 10B. FIG. 10A is a schematic diagram illustrating an example of a display aspect of a tree structure of words/phrases. FIG. 10B is an example of a data structure in the case of the tree structure of FIG. 10A. As illustrated in FIG. 10A, for a segment of “area”, a word/phrase D14 of “Korea” and a word/phrase D15 of “Japan” are provided. The word/phrase D15 of “Japan” has a word/phrase D16 of “Kanto” and a word/phrase D17 of “Osaka” as child nodes, and the word/phrase of “Kanto” has a word/phrase D18 of “Tokyo” as a child node.

As illustrated in FIG. 10B, as an example, the data structure in the case of the tree structure of FIG. 10A is represented in a JSON format. In the data structure of FIG. 10B, a key “element” is assigned to a word/phrase, and a key “children” is assigned to a child element. As a result, child elements of “area” have “Korea” and “Japan”, there are no child elements of “Korea” but child elements of “Japan” have “Kanto” and “Osaka”, child elements of “Kanto” have “Tokyo”, and “Osaka” do not have child elements. In addition, “Tokyo” has no child element.

As described above, there is illustrated a data structure having a tree structure used when the terminal 1 having the processor 16 displays a plurality of words/phrases in a tree structure, in which the data structure has a word/phrase in association with a root node and has a word/phrase in association with each of at least one or more first child nodes associated with the root node, the first child node an further have at least one or more second child nodes and can have a word/phrase in association with each of the second child nodes, and the processor 16 is caused to read the data structure to display words/phrases in the data structure in a tree structure.

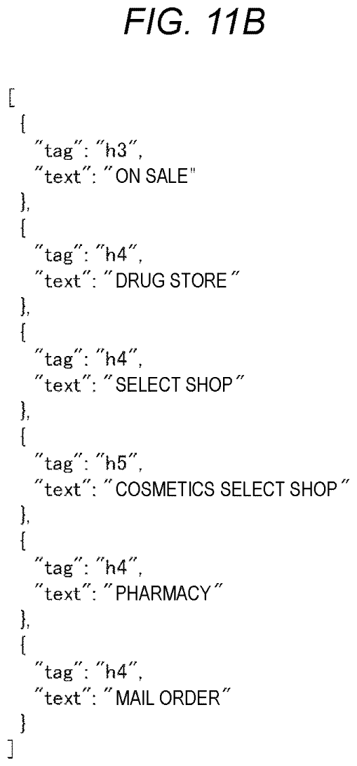

FIG. 11A is an example of a display screen after a target search query is input. As illustrated in FIG. 11A, a display screen G3a is provided with a selector S1, and as an example, since the number of top appearance pages is selected through the selector S1, a color corresponding to the number of top appearance pages is added to each sub-search word/phrase next to the sub-search word/phrase.

As illustrated in FIG. 11A, the display screen G3a is provided with a sub-search word/phrase list button B1, a contained word/phrase button B2, a save button B3, a read button B4, a clear button B5, a highlight setting button B6, a docx button B7, and an xlsx button B8. The functions of the sub-search word/phrase list button B1 and the contained word/phrase button B2 will be described later.

When the save button B3 is pressed, the tree structure data displayed on the display screen G3a is transmitted to the computer system 2 and saved in the storage 23. Accordingly, by pressing the read button B4, the tree structure data stored in the storage 23 can be read.

When a cursor C11 is dragged and dropped to a region R11 on the display screen G3a, a combination of a heading tag (h tag) assigned according to the hierarchy of each node of the tree structure and a word/phrase of the node is displayed in an editing space on the right side as shown in a region R21 of the display screen G3b. For example, an h3 tag is allocated to “on sale” which is the highest node in the tree structure to be dragged, and an h4 tag, which is used as the next largest heading after the h3 tag, is assigned to “drug store”, “select shop”, “pharmacy”, and “online shopping” which are child nodes of “on sale”. Furthermore, an h5 tag, which is used as the next largest heading after the h4 tag, is assigned to “cosmetic select shop” which is a child node of “select shop”. As described above, a word/phrase of a node is one word or a new word or a phrase in which a plurality of words are combined.

This process is realized by the following processing. That is, when a specific operation (for example, drag & drop) is executed by the user on a part or all of the displayed tree structure, the processor 16 of the terminal 1 executes, for example, a code (client side script, e.g. JavaScript) provided from the computer system 2, and outputs information for displaying a combination of a corresponding heading tag (h tag) and a word/phrase of a corresponding node assigned according to the hierarchy of each node of the tree structure. At this time, as one aspect, for example, the processor 16 assigns an h2 tag to a root node (that is, a node of the highest hierarchy), an h3 tag to a child node of the root node (a node of the second highest hierarchy), an h4 tag to a child node of a child node of the root node (a node of the third highest hierarchy), and an h5 tag to a child node of a child node of a child node of the root node (a node of the fourth highest hierarchy). As described above, for example, the processor 16 sequentially assigns heading tags having larger numerical values as the hierarchy of a node of the tree structure becomes deeper such that the characters of the headings become smaller as the hierarchy of the node of the tree structure becomes deeper. As a result, the display screen G3b is displayed on the display 17 connected to the terminal 1.

Although the h2 tag is assigned to the root node as an example, the present invention is not limited thereto, and tags of h1 tag, h3 tag or more may be assigned, and other nodes are not limited to the above example.

FIG. 11B is an example of a data structure for displaying and/or holding data of the region R12 in FIG. 11A. As illustrated in FIG. 11B, as an example, the data structure for displaying and/or holding the data of the region R12 of the display screen G3b in FIG. 11A is represented in a JSON format. In the data structure of FIG. 11B, a key “tag” is assigned to the heading tag (h tag), and a key “text” is assigned to a word/phrase.

This data structure may be generated by the processor 16 executing a code (client side script, e.g., JavaScript) provided from the computer system 2 in response to, for example, a specific operation (for example, an operation of dragging and dropping the tree structure to the region R11) and held in the memory 14. Then, the processor 16 may display a combination of a heading tag and a word/phrase in the data structure by reading the data structure.

Alternatively, this data structure may be generated by the processor 16 executing a code (client side script, e.g. JavaScript) provided from the computer system 2 and held in the storage 13, for example, after a combination of a heading tag and a word/phrase is displayed in the region R12 after the tree structure is dragged and dropped to the region R11 and, for example, when the save button B3 in FIG. 11A is pressed. Then, when the read button B4 in FIG. 11A is pressed, for example, the processor 16 may read this data structure from the storage 13 to display again a combination of a heading tag and a word/phrase in the data structure.

As described above, there is illustrated a data structure used when the terminal 1 including the processor 16 displays and/or holds a heading tag of a heading of a web page and a word/phrase in the heading, in which the data structure has a word/phrase associated with a heading tag, and the processor 16 reads the data Structure to display a combination of a heading tag and a word in the data structure.

The clear button B5 is a button for erasing character strings in the region R12 of the display screen G3b, and when the clear button B5 is pressed, for example, the processor 16 of the terminal 1 erases the character strings in the region R12 of the display screen G3b.

The highlight setting button B6 is a button for setting settings (color arrangement) and the like in a case where character strings in the region R12 of the display screen G3b are displayed in a highlighting manner. The processor 16 of the terminal 1 opens a highlight setting screen by pressing the highlight setting button B6.

When the docx button B7 is pressed, the processor 16 of the terminal 1 saves the character strings in the region R12 of the display screen G3b in the file format of an editor (for example, WORD).

When the xlsx button B8 is pressed, the processor 16 of the terminal 1 saves the character strings in the region R12 of the display screen G3b in the file format of spreadsheet software (for example, EXCEL (registered trademark)).

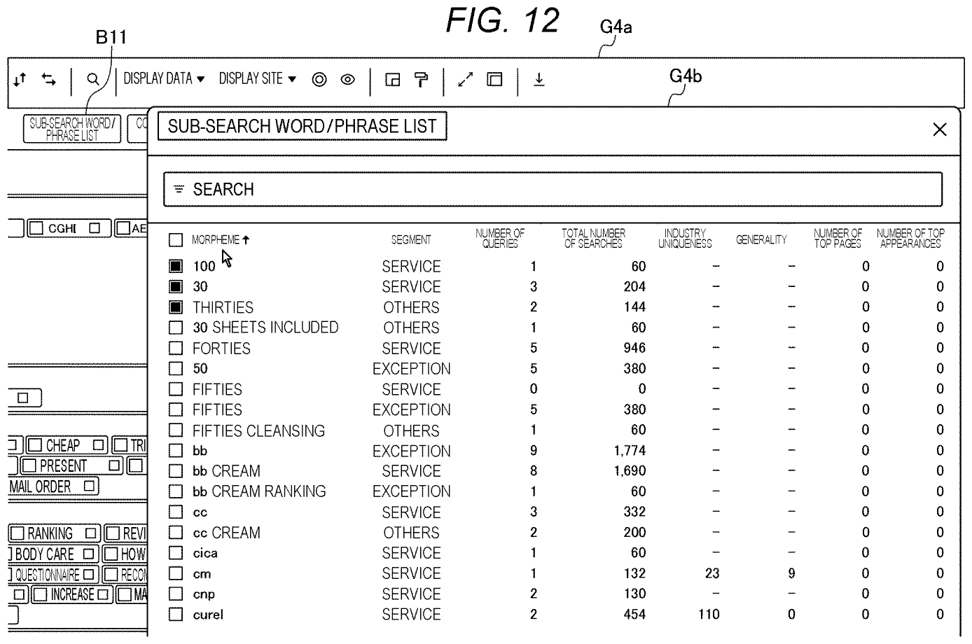

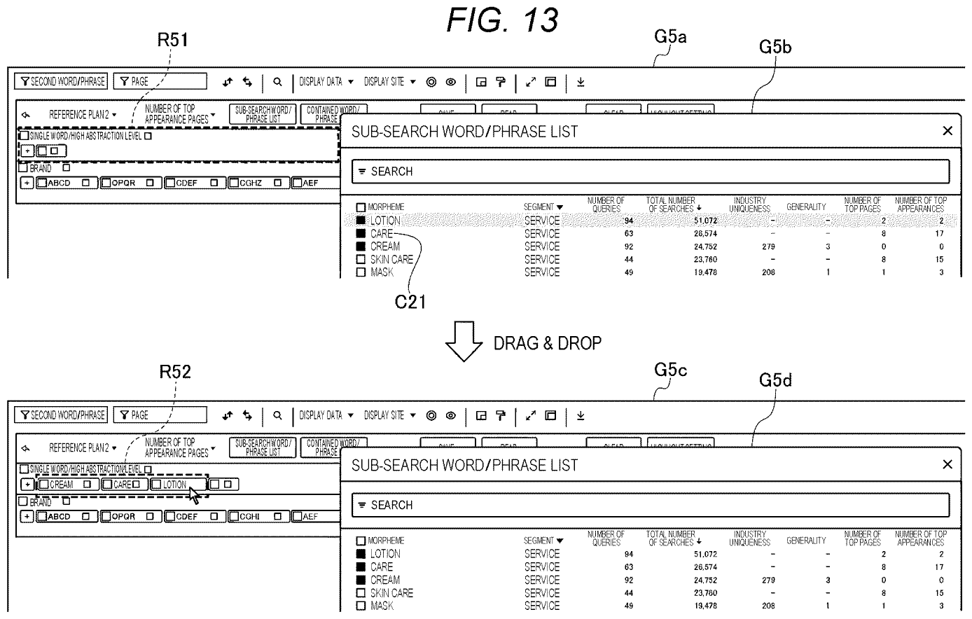

Next, processing of adding a word/phrase from a sub-search word/phrase list to a word/phrase list to be edited will be described using FIG. 12 to FIG. 15. FIG. 12 is an example of a display screen in a case where the sub-search word/phrase list button is pressed. FIG. 13 is a schematic diagram illustrating a process of adding a sub-search word/phrase from the sub-search word/phrase list to a word/phrase list to be edited.

As illustrated in FIG. 12, when the sub-search word/phrase list button B11 is pressed on a display screen G4a, as an example, a screen G4b containing the sub-search word/phrase list is displayed as a pop-up. This sub-search word/phrase list is a list of sub-search words/phrases used in a search query together with a target search query that is a target. In the sub-search word/phrase list, as an example, a word/phrase used as a sub-search word/phrase together with a target search query during a search query, a segment thereof, the number of types of search queries including the target search query and the sub-search word/phrase (also referred to as the number of queries), the total number of searches of search queries including the target search query and the sub-search word/phrase (also simply referred to as the total number of searches), and a set of industry uniqueness, generality, the number of top pages, and the number of top appearances are displayed in a list.

In addition, the industry uniqueness is an index indicating how distinctively a sub-search word/phrase is used on top pages of a search query including both a target search query and the sub-search word/phrase. For example, the industry uniqueness is a parameter set such that it increases as the appearance frequency in a top page group of search results by a search query including both a target search query (for example, “cad”) and a sub-search word/phrase increases and increases as the frequency in a top page group of search results of other search query groups including both the target search query (for example, “cad”) and other sub-search words/phrases decreases. This industry uniqueness may be, for example, the uniqueness of Patent Literature 2 (Japanese Patent No. 6253041), and specifically, for example, the uniqueness of the word/phrase as an industry term may be calculated on the basis of a predetermined evaluation function, but is not limited thereto.

The generality is a value indicating the degree to which the corresponding word/phrase is widely and generally used not only in a specific industry, and is a parameter set such that it becomes a higher value as the frequency of use in many documents, regardless of industry, increases. For example, since “desu”, “masu”, and the like are used not only in documents but also at a high frequency, the degree of generality increases, and since “natural language” and the like are words used in specific documents, the degree of use is low and the generality is low unless the industry is limited.

The number of top pages is the number of web pages in which a target word/phrase is contained in the corresponding top web page of search results, assuming that up to a predetermined rank is a top rank. Specifically, it is an index indicating the number of web pages in which a target word/phrase appears among web pages ranked in the top K (K is a natural number) in search results.

The number of top appearances is the number of appearances of a target word/phrase in the corresponding top web page of search results, assuming that up to a predetermined rank is a top rank. Specifically, it is an index indicating the number of times a target word/phrase is contained in the top K web pages in search results.

There may be an economic scale in addition to or in place of the total number of searches. The economic scale indicates how much economic scale is present for one or more search queries from which sub-search words/phrases were extracted. The economic scale of a target sub-search word/phrase is, for example, the sum of values obtained by multiplying any two or three of the number of searches per unit period (for example, month) (also referred to as a search volume), a click price of a PPC advertisement displayed in search results of the search query, and the competitiveness of the PPC advertisement for each of a target search query and a search query including the sub-search word/phrase.

Words/phrases can be sorted by these parameters. This sorting is realized by the following processing. That is, in response to a sorting operation of the user for a list of sub-search words/phrases, the processor 26 of the computer system 2 outputs information for displaying a list in which the sub-search words/phrases are sorted according to the segments of the sub-search words/phrases, the number of types of search queries including the target search query and the sub-search words/phrases, the total number of searches or the economic scale of search queries including the target search query and the sub-search words/phrases, the industry uniqueness of the sub-search words/phrases, the generality of the sub-search words/phrases, the number of web pages in which the sub-search words/phrases appear in search top web pages, or the frequency of appearance of the sub-search words/phrases in the search top web pages. As a result, the terminal 1 can receive the output information and display a list in which contained words/phrases are sorted by using the information.

As illustrated in FIG. 13, when a cursor C21 is dragged and dropped to a region R51 of a display screen G5a in a state in which “cosmetics”, “care”, and “cream” have been selected on a screen G5b popped up on the display screen G5a, “cosmetics”, “care”, and “cream” are added to a word/phrase list of the category “single word/high abstraction level” as shown in a region R52 of a screen G5c. In this manner, the user can select a desired word/phrase from the sub-search word/phrase list and add the word/phrase to the word/phrase list.

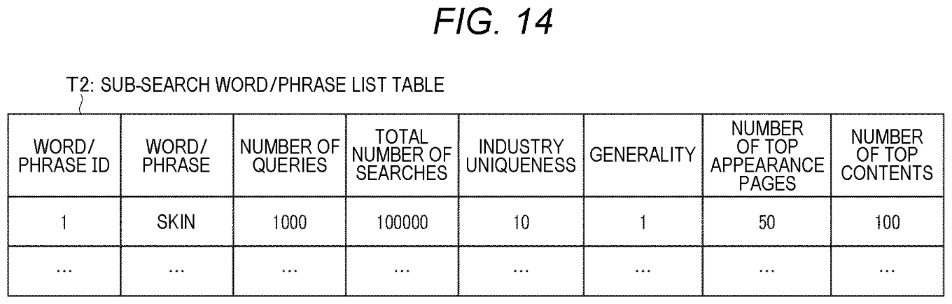

FIG. 14 is an example of a sub-search word/phrase list table stored in the storage 23 in a processing process. In the sub-search word/phrase list table T2, a set of a word/phrase ID which is identification information for identifying a word/phrase, the word/phrase, the number of queries, the total number of searches, industry uniqueness, generality, the number of top appearance pages, and the top containing number is stored.

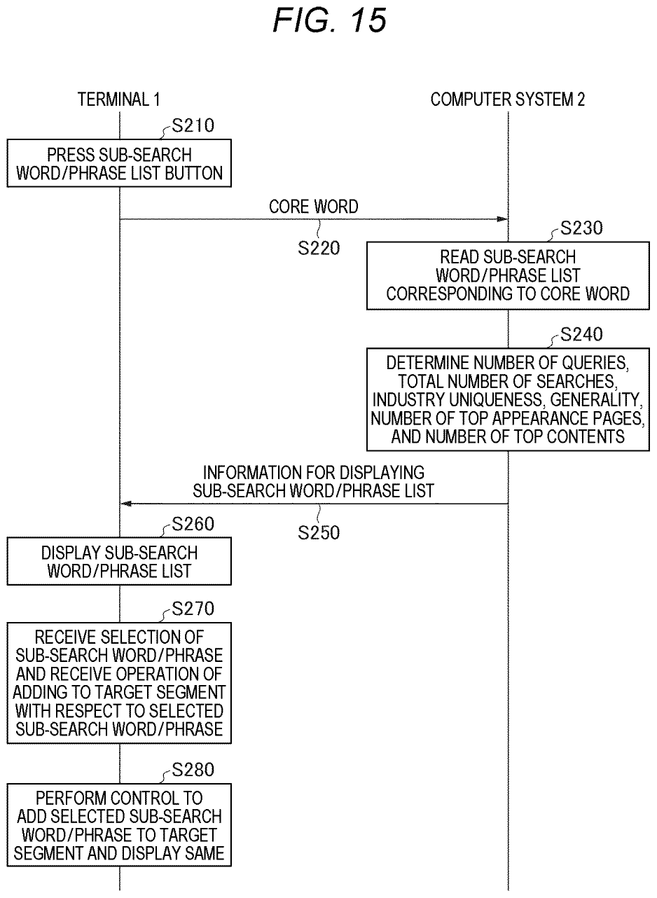

FIG. 15 is a flowchart illustrating an example of a flow of processing of adding a sub-search word/phrase from a sub-search word/phrase list to a tree structure.

(Step S210) The terminal 1 receives, from the user, pressing of the sub-search word/phrase list button on the display screen.

(Step S220) In this case, the terminal 1 transmits a target search query to the computer system 2.

(Step S230) Upon receiving the target search query, the computer system 2 reads a sub-search word/phrase list corresponding to the target search query from the storage 23.

(Step S240) The computer system 2 determines the number of queries, the total number of searches, the industry uniqueness, the generality, the number of top appearance pages, and the top containing number, and stores the same in the sub-search word/phrase list table T2 of the storage 23.

Here, the number of queries is obtained by counting the number of types of search queries including the target search query and target sub-search words/phrases from a sub-query list.

The total number of searches is obtained by acquiring, from the search engine server 3, the total number of searches of search queries including the target search query and the target sub-search words/phrases.

The industry specific number is obtained by counting the sub-search words/phrases contained in the top (up to a predetermined rank) web pages of search results for each of a plurality of combinations of the target search query and the sub-search words/phrases and applying the counted sub-search words/phrases to, for example, a predetermined evaluation function (refer to Patent Literature 2).

As an example, the generality is obtained by acquiring from a database in which frequency information on words/phrases that appear on many pages, not just the top pages in the search results for the target search query, has been registered in advance.

The number of top appearance pages is obtained by counting the number of web pages in which the target word/phrase is contained in the top (up to a predetermined rank) web pages of the search results.

The number of top appearances is obtained by counting the number of times the target word/phrase appears in the top (up to a predetermined rank) web pages of the search result.

(Step S250) The computer system 2 generates information for displaying the sub-search word/phrase list, and transmits the information to the terminal 1. Here, the information for displaying the sub-search word/phrase list is information for displaying the sub-search word/phrase list in a sortable manner by the number of queries, the total number of searches, the industry uniqueness, the generality, the number of top appearance pages, and the top containing number.

(Step S260) Upon receiving the information for displaying the sub-search word/phrase list, the terminal 1 displays the sub-search word/phrase list using the information.

(Step S270) Next, the terminal 1 receives selection of a sub-search word/phrase from the user, and receives an operation of adding the selected sub-search word/phrase to a target segment from the user.

(Step S280) Next, upon receiving the adding operation, the terminal 1 performs control to add the selected sub-search word/phrase to the target segment and display the same.

In this manner, the processor 26 of the terminal 1 outputs the information for displaying the sub-search word/phrase list according to the operation of the user. Then, the processor 26 of the terminal 1 performs control to add the selected sub-search word/phrase to the word/phrase list of the target segment and display the same according to user operation of selecting the sub-search word/phrase in the sub-search word/phrase list and adding the same to the target segment. As a result, the sub-search word/phrase in the sub-search word/phrase list can be added to the word/phrase list of the target segment.

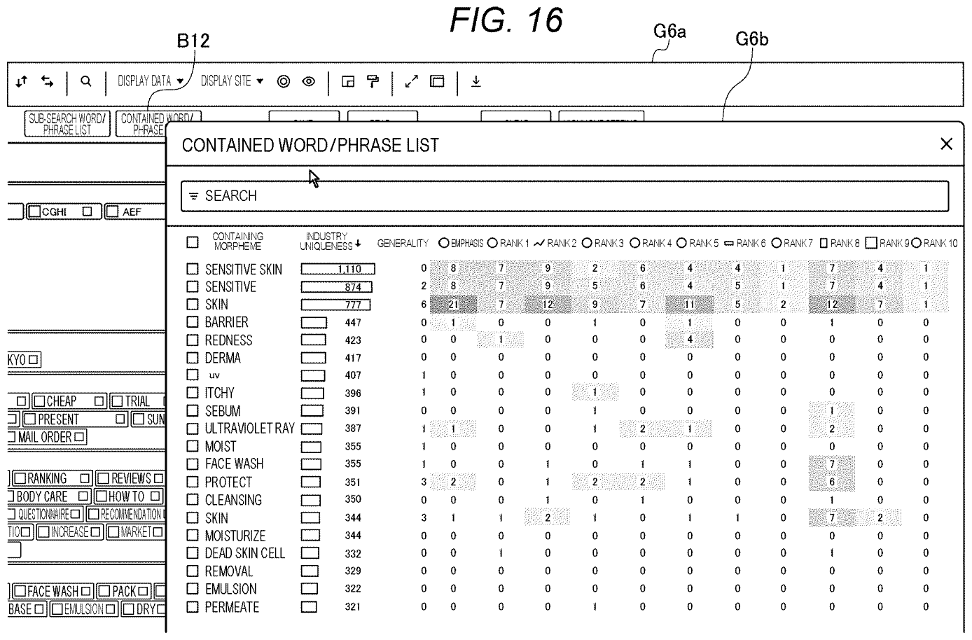

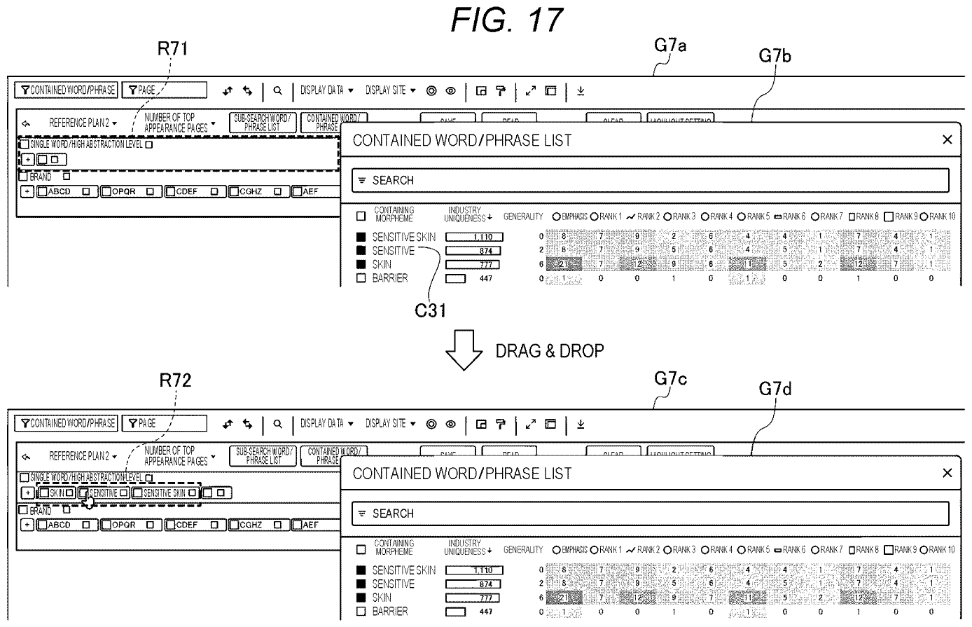

Next, processing of adding a word/phrase from a contained word/phrase list to a word/phrase list to be edited will be described using FIG. 16 and FIG. 17. FIG. 16 is an example of a display screen when the contained word/phrase list button is pressed. FIG. 17 is a schematic diagram illustrating a process of adding a word/phrase from a contained word/phrase list to a word/phrase list to be edited.

As illustrated in FIG. 16, when the contained word/phrase list button B12 is pressed on a display screen G6a, as an example, a screen G6b containing the contained word/phrase list is displayed as a pop-up. This contained word/phrase list is a list of words/phrases contained in web pages up to a predetermined rank in search results of a target search query.

In the contained word/phrase list, as an example, a set of a contained word/phrase, the industry uniqueness of the contained word/phrase, the generality of the contained word/phrase, a frequency at which the contained word/phrase is emphasized, and a frequency at which the contained word/phrase appears on each web page of the first to tenth search rankings is displayed in a list.

Words/phrases can be sorted by these parameters. This sorting is realized by the following processing. That is, the processor 26 of the computer system 2 outputs information for displaying a list in which contained words/phrases are sorted according to industry uniqueness of the contained words/phrases, generalities of the contained words/phrases, frequencies at which the contained words/phrases are emphasized, and frequencies at which the contained words/phrases appear on a web page having a specific search ranking according to a sorting operation of the user on the list of contained words/phrases. As a result, the terminal 1 can receive the output information and display a list in which contained words/phrases are sorted by using the information.

As illustrated in FIG. 17, in a state in which “sensitive skin”, “sensitive”, and “skin” have been selected on a screen G7b popped up on a display screen G7a, when a cursor C31 is dragged and dropped to a region R71 of the screen G7a, “sensitive skin”, “sensitive”, and “skin” are added to the word/phrase list of the category “single word/high abstraction level” as shown in a region R72 of the screen G7c. In this manner, the user can select a desired word/phrase from the contained word/phrase list and add the same to the word/phrase list.

This process is realized by the following processing. That is, the processor 26 of the terminal 1 outputs information for displaying a list of contained words/phrases according to user operation. Then, the processor 26 of the terminal 1 performs control to add a selected contained word/phrase to the word/phrase list of the target segment and display the same according to user operation of selecting the contained word/phrase in the list of contained words/phrases and adding the same to the target segment. As a result, the contained word/phrase in the contained word/phrase list can be added to the word/phrase list of the target segment.

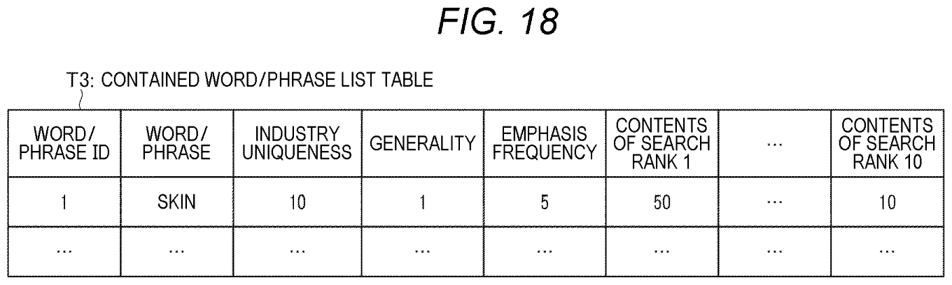

FIG. 18 is an example of a contained word/phrase list table stored in the storage 23 in a processing process. In the contained word/phrase list table T3, records of a set of a word/phrase ID, a word/phrase, an industry uniqueness, a generality, a frequency at which the contained word/phrase is emphasized (also referred to as an emphasis frequency), and a frequency at which the contained word/phrase appears in each of web pages of the first to tenth search rankings are accumulated.

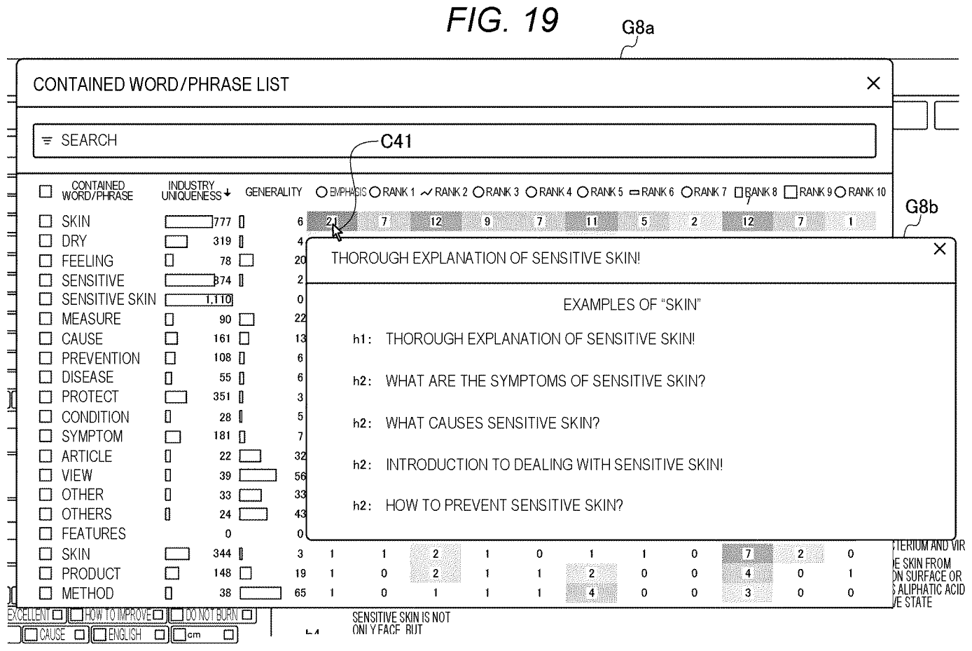

FIG. 19 is an example of a screen containing examples of a word/phrase selected by the user. As illustrated in FIG. 18, when a screen G8a containing a contained word/phrase list is clicked by a cursor C41, a screen G8b containing examples of the contained word/phrase “skin” corresponding to the position of the cursor C41 is displayed as a pop-up. Here, the examples are examples of a target contained word/phrase (here, “skin” as an example) contained in web pages up to a predetermined rank (for example, tenth rank) in search results of a target search query. On the screen G8b, examples are displayed together with heading tags (h tags) in which the examples appear.

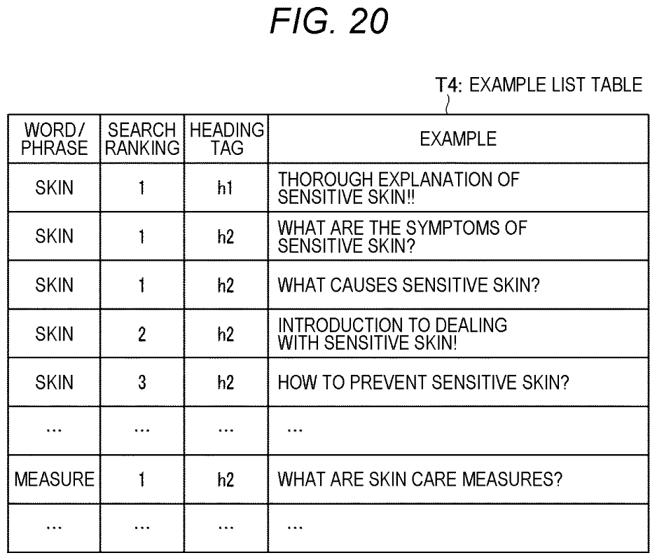

The examples are extracted by processing associated with designation of the target search query by the user and stored in, for example, an example list table T4 illustrated in FIG. 20. FIG. 20 is an example of the example list table T4 of the storage 23. As illustrated in FIG. 19, records of a set of a word/phrase, a search rank, a heading tag, and an example are accumulated in the example list table T4. Accordingly, it is possible to read and display examples with respect to each contained word/phrase by referring to the example list table T4.

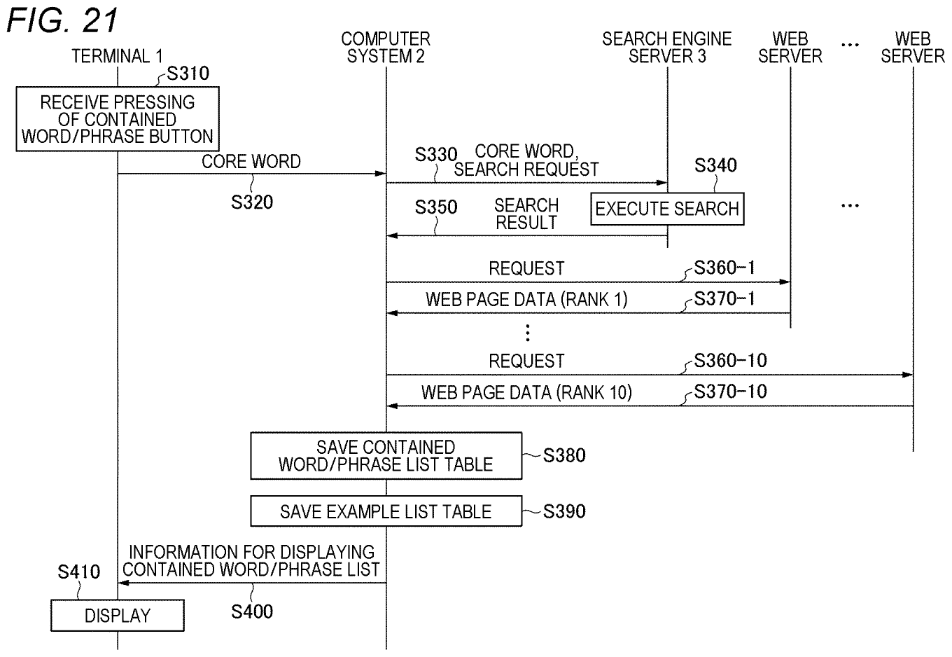

FIG. 21 is a flowchart illustrating an example of a flow of processing of adding a contained word/phrase from a contained word/phrase list to a target word/phrase list. Here, processing after the processing illustrated in FIG. 7 is completed will be described. That is, it is assumed that the target search query has already been input and is held on the side of the terminal 1.

(Step S310) The terminal 1 receives press of the contained word/phrase button by the user.

(Step S320) Upon receiving the press of the contained word/phrase button by the user in step S310, the terminal 1 transmits the target search query to the computer system 2.

(Step S330) Upon receiving the target search query, the computer system 2 transmits a search request to the search engine server 3 together with the target search query.

(Step S340) Upon receiving the search request, the search engine server 3 executes search.

(Step S350) Next, the search engine server 3 transmits search results to the computer system 2.

(Steps S360-1 to S360-10) The computer system 2 requests each of web pages of the first to tenth search rankings from a web server corresponding thereto. (Steps S370-1 to S360-10) The computer system 2 receives web page data of each of the first to tenth search rankings transmitted in response to the request.

(Step S380) The computer system 2 stores contained words/phrases of the web page data of each of the first to tenth search rankings in the contained word/phrase list table T3 of the storage 23. At this time, the computer system 2 acquires the industry uniqueness and the generality for each word/phrase, counts and acquires the emphasis frequency and the frequency of appearance of the contained word/phrase in each of the web pages of the first to tenth search rankings for each word/phrase, and stores the same in the contained word/phrase list table T3 for each combination. As a result, records of a set of a contained word/phrase, the industry uniqueness of the contained word/phrase, the generality of the contained word/phrase, the frequency at which the contained word/phrase is emphasized, and the frequency at which the contained word/phrase appears on each of the web pages of the first to tenth search rankings are accumulated in the contained word/phrase list table T3. Here, the industry uniqueness and the generality may be acquired as in step S240 of FIG. 15 or may be acquired from the sub-search word/phrase list table T2.

(Step S390) In addition, the computer system 2 stores the examples contained in the web page data of each of the first to tenth search rankings in the example list table. As a result, for example, the example list table T4 of FIG. 19 is stored in the storage 23.

(Step S400) The computer system 2 transmits information for displaying the contained word/phrase list to the terminal 1.

(Step S410) Upon receiving the information for displaying the contained word/phrase list, the terminal displays the contained word/phrase list using this information.

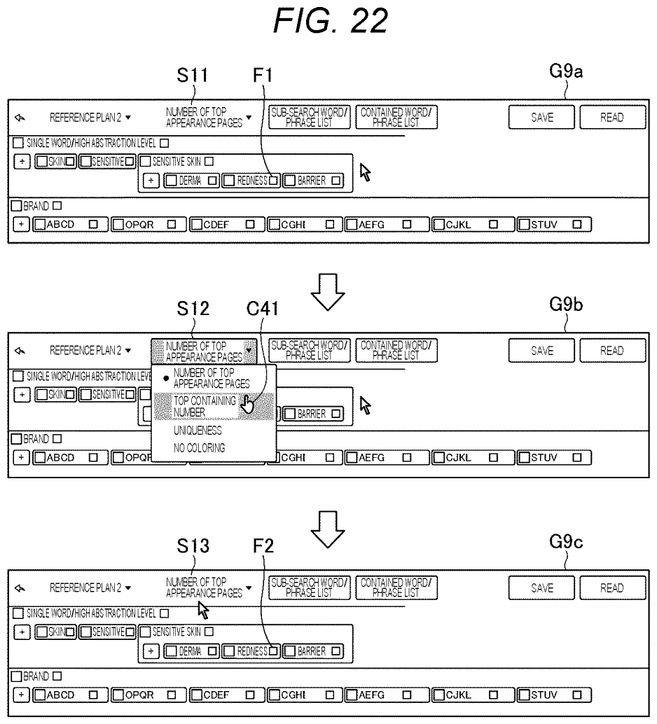

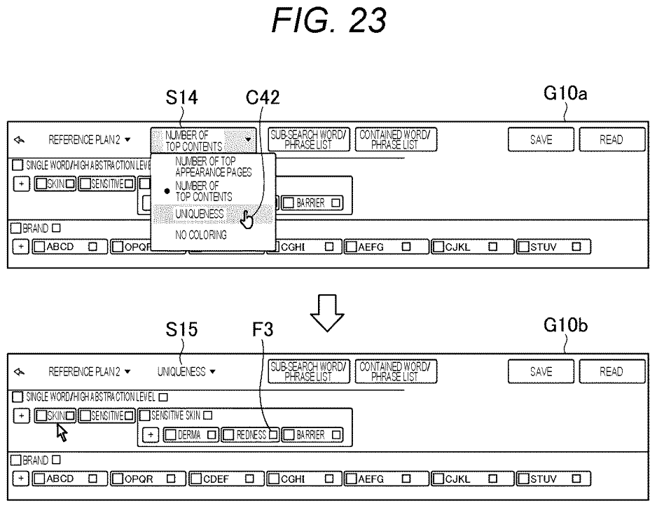

Subsequently, a display aspect in which additional information for each word/phrase is displayed at the time of displaying a word/phrase list will be described using FIG. 22 and FIG. 23.

FIG. 22 is a schematic diagram illustrating an example of a display aspect of additional information for each word/phrase in a word/phrase list. FIG. 23 is a continuation of FIG. 22.

In a screen G9a of FIG. 22, a selector S11 is “number of top appearance pages” and the magnitude of the number of top appearance pages is displayed in color as indicated by a box F1 or the like for each word/phrase in the word/phrase list. It may not be a color, and may be a number itself of the number of top appearance pages, a bar graph, or the like, as long as a human can visually recognize the magnitude of the number of top appearance pages.

As illustrated in a screen G9b of FIG. 22, when a cursor C41 is adjusted to “a top containing number” while a selector S12 is left-clicked, “top containing number” is selected by a selector S13 as illustrated in a screen G9c. Accordingly, for each word/phrase in the word/phrase list, the magnitude of the top containing number is displayed in color as indicated by a box F2 or the like. It may not be a color, and may be a number itself of the top contents, a bar graph, or the like, as long as a human can visually recognize the magnitude of the top containing number.

As illustrated in a screen G10a of FIG. 23, when a cursor C42 is adjusted to “uniqueness” while a selector S14 is left-clicked, “uniqueness” is selected by a selector S15 as illustrated in a screen G10b. Here, the “uniqueness” is industry uniqueness. Accordingly, for each word/phrase in the word/phrase list, the magnitude of the industry uniqueness is displayed in color as indicated by a box F3 or the like. It may not be a color, and may be a number itself of the industry uniqueness, a bar graph, or the like, as long as a human can visually recognize the magnitude of the uniqueness.

In a case of realizing such processing, for example, as described in step S240 of FIG. 15, the processor of the computer system 2 acquires the number of top appearance pages, the top containing number, and the industry uniqueness for each word/phrase (for example, sub-query word/phrase). Then, for example, the processor 16 of the terminal 1 may receive a set of a word/phrase (for example, sub-query word/phrase), the number of top appearance pages, the top containing number, and the industry uniqueness from the computer system 2, and hold each word/phrase in the memory 13 of the terminal 1 in association with the number of top appearance pages, the top containing number, and the industry uniqueness. Accordingly, the processor 16 of the terminal 1 can change the display by reading and displaying corresponding data stored in the memory according to selection of the user.

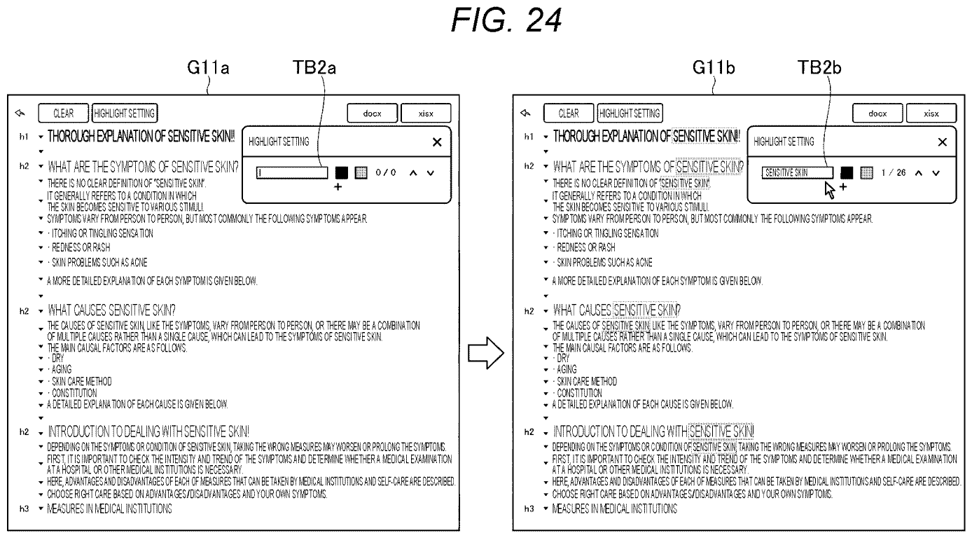

FIG. 24 is a schematic diagram illustrating a flow of highlight setting. An editing region G11a in FIG. 24 is an editing region after a word/phrase is dragged and dropped from a target word/phrase list. This editing region corresponds to the editing region on the right side of the screen G3b in FIG. 11A. In the editing region G11a of FIG. 24, a text box TB2a for inputting a character string to be highlighted is provided. In the editing region G11b of FIG. 24, when a character string (here, “sensitive skin” as an example) is input to the text box TB2, the processor 16 of the terminal 1 performs control to highlight the character string.

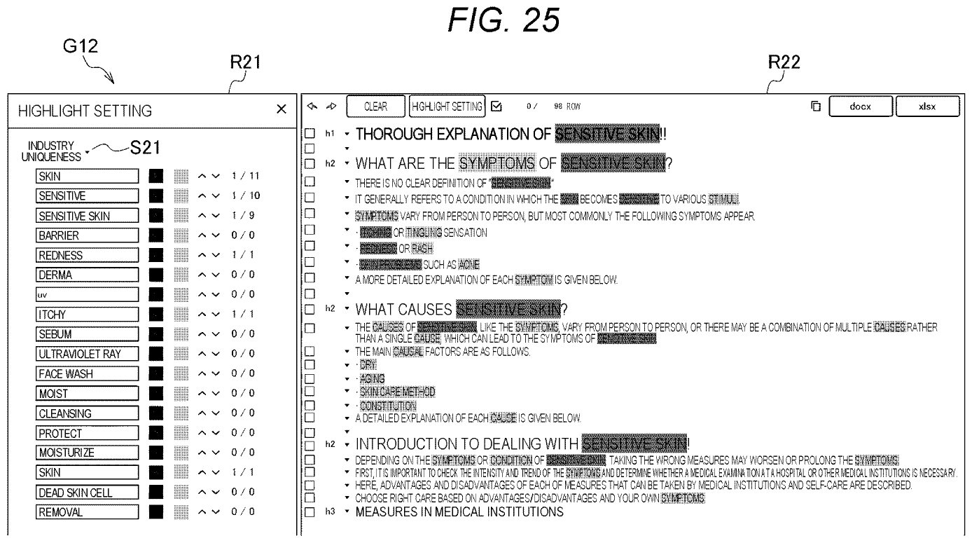

FIG. 25 is a schematic diagram of heat map display obtained by extending the highlight setting of FIG. 24. In a highlight setting region R21 of a screen G12, indexes such as the above-described industry uniqueness, the number of top appearance pages, and the top containing number are selected through a selector S21, and highlight presenting a stepwise color change is automatically set on the basis of the selected indexes, thereby realizing heat map display depending on the magnitude of the selected indexes.

FIG. 25 illustrates, as an example, a state in which the industry uniqueness is selected by the user through the selector S21, and in response to the selection by the user, the processor 16 of the terminal 1 performs control to display a highlight that presents a stepwise color change according to the magnitude of the industry uniqueness for each word/phrase in the word/phrase list displayed in the highlight setting region R21. As a result, a highlight that presents a stepwise color change according to the magnitude of the industry uniqueness is displayed for each word/phrase in the word/phrase list displayed in the highlight setting region R21 in an editing region R22 of FIG. 25.

### Modified Examples

Although, in a case where a target search query of web content is received from the user, information for displaying a plurality of sub-search words/phrases used for search together with the target search query in other search queries as a word/phrase list for each segment is output in the information processing system S of the present embodiment, the present invention is not limited thereto, and in addition or in place of this, information for displaying a plurality of contained words/phrases of web pages up to a predetermined rank in search results of the target search query as a word/phrase list for each segment may be output.

In the present embodiment, it is described that the computer system 2 includes one storage 23, but the present invention is not limited thereto, and two or more storages may be provided, or the terminal 1 may include at least one storage. In this manner, the information processing system S may include at least one storage.

In the present embodiment, it is described that the computer system 2 includes one processor 26, but the present invention is not limited thereto, and the computer system 2 may include a plurality of processors 26. In addition, some processing of the processor 26 of the computer system 2 may be executed by the processor 16 of the terminal 1, and a plurality of processors of the terminal 1 may be provided and may execute the processing. In this manner, the information processing system S may include at least one processor 26.

As described above, the information processing system according to one aspect includes the computer system 2 and the terminal 1. Upon receiving a target search query of web content from a user, the computer system 2 outputs information for displaying a plurality of sub-search words/phrases used for search together with the target search query in another search query and/or a plurality of contained words/phrases mentioned on web pages up to a predetermined rank in search results of the target search query as a word/phrase list having a tree structure. The terminal 1 outputs information for displaying a combination of a heading tag and a word/phrase of a node assigned according to the hierarchy of each node of the tree structure when a specific operation is executed by the user on a part or all of the displayed tree structure. At this time, specifically, for example, a character string of a heading tag and/or a word/phrase is displayed in an editable manner.

According to this configuration, a plurality of sub-search words/phrases used for search together with the target search query in a search query and/or a plurality of contained words/phrases mentioned on web pages up to a predetermined rank in search results of the target search query are displayed as a word/phrase list in a tree structure. Only by the user performing a specific operation (for example, drag and drop) on the tree structure, words/phrases are displayed (for example, in an editable manner) in a state in which heading tags are assigned according to the hierarchy of the tree structure, and thus it is possible to reduce effort to create a web page by creating a web page using the words/phrases.

In addition, the terminal 1 according to one aspect includes at least one processor 16, and the at least one processor 16 updates the tree structure such that another contained word/phrase is added to a child node of a sub-search word/phrase in response to a user operation of adding another contained word/phrase to a lower layer of the sub-search word/phrase on a display screen on which a plurality of words/phrases including sub-search words/phrases and contained words/phrases are displayed.

With this configuration, the user can easily update the tree structure for a word/phrase having a search need. As a result, only by the user performing a specific operation (for example, drag and drop) on the updated tree structure, words/phrases are displayed (for example, in an editable manner) in a state in which heading tags are assigned according to the hierarchy of the updated tree structure, and thus it is possible to reduce effort to create a web page.

### Second Embodiment

Next, a second embodiment will be described. In the second embodiment, information displayed on a display screen is different from that in the first embodiment. In addition, as an example, a display aspect in a hierarchical structure may be displayed in a tree structure. Since a hardware configuration of an information processing system in the second embodiment is similar to that of the first embodiment, the description thereof will be omitted.

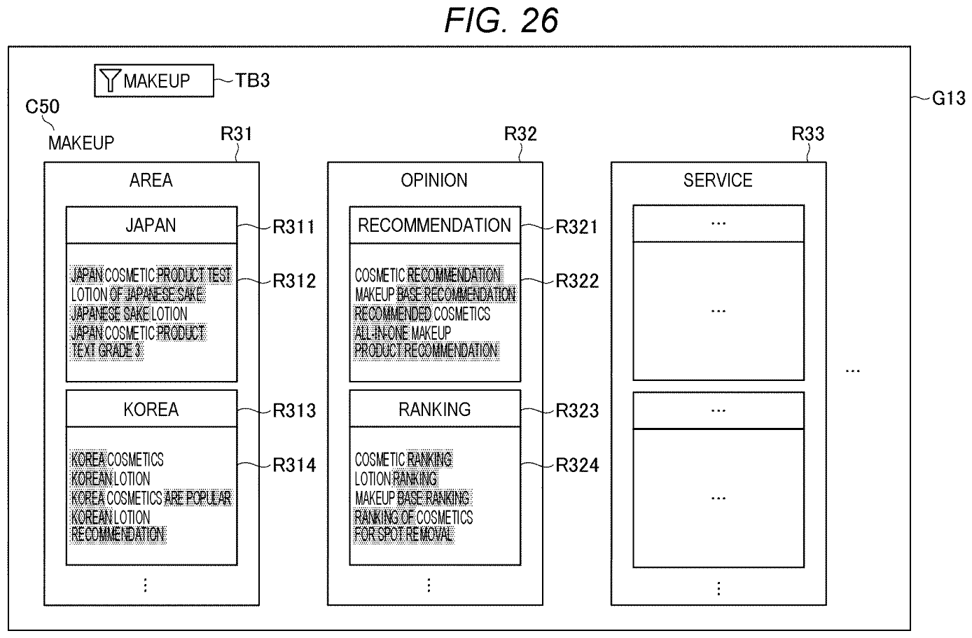

FIG. 26 is an example of a schematic diagram of a display screen according to the second embodiment. As illustrated in FIG. 26, a text box TB3 for inputting a target search query representing a subject of each web page of a website is indicated on the display screen G13 of the terminal 1. The display screen G13 of the terminal 1 is an example of a screen displayed as a result of inputting “makeup” to the text box TB3, for example. As a result of inputting “makeup” to the text box TB3, a target search query C50 of “makeup” is displayed.

Information is displayed for each segment on the display screen G13. Here, the segment represents a classification of a plurality of sub-search words/phrases used for search together with the target search query in a search query, and examples thereof include an area, an opinion, a service, and the like.

The segment “area” includes, for example, sub-search words/phrases such as “Japan” and “Korea”. Here, a screen region R31 of the segment “area” contains a screen region R311 including a sub-search word/phrase “Japan” used for search together with the target search query “makeup” in the search query, and a screen region R312 including search linking words/phrases (for example, “Japan cosmetic product test”, “lotion of Japanese sake”, “Japanese sake lotion”, and “Japan cosmetic product test grade 3”) including the target search query “makeup” and the sub-search word/phrase “Japan”. Here, as an example, the screen region R312 is displayed below and adjacent to the screen region R311. The present invention is not limited thereto, and the search linking words/phrases may be displayed in association with the sub-search word/phrase.

Similarly, the screen region R31 of the segment “area” contains a screen region R313 including a sub-search word/phrase “Korea” used for search together with the target search query “makeup” in the search query, and a screen region R314 including search linking words/phrases (for example, “Korean cosmetics”, “Korean lotion”, “Korean cosmetics are popular”, and “Korean cosmetics recommendation”) including the target search query “makeup” and the sub-search word/phrase “Korea”.

The segment “opinion” includes, for example, sub-search words/phrases “recommendation” and “ranking”. Here, a screen region R32 of the segment “opinion” contains a screen region R321 including the sub-search word/phrase “recommendation” used for search together with the target search query “makeup” in the search query, and a screen region R322 including search linking words/phrases (for example, “cosmetics recommendation”, “makeup base recommendation”, “recommended cosmetics”, and “all-in-one cosmetics recommendation”) including the target search query “makeup” and the sub-search word/phrase “recommendation”.

Similarly, the screen region R32 of the segment “opinion” contains a screen region R323 including the sub-search word/phrase “ranking” used for search together with the target search query “makeup” in the search query, and a screen region R324 including search linking words/phrases (for example, “cosmetic ranking”, “lotion ranking”, “makeup base ranking”, and “ranking of cosmetics for spot removal”) including the target search query “makeup” and the sub-search word/phrase “ranking”.

In order to realize a display on the display screen G13, when receiving a target search query of web content from the user, for example, the processor 26 of the computer system 2 outputs information for displaying a plurality of sub-search words/phrases used for search together with the target search query in another search query, and a search linking words/phrases including the target search query and the sub-search words/phrases such that the search linking words/phrases are associated with the sub-search words/phrases. This processing may be executed by a plurality of processors. Here, a sub-search word/phrase is one word or a new word or a phrase in which a plurality of words are combined.

With this configuration, the user can ascertain search linking words/phrases used in search for each of sub-search words/phrases (for example, “Japan”, “Korea”, “recommendation”, and “ranking”) used in the search together with a target search query and can select a search linking word/phrase described in a web page from among the search linking words/phrases, and thus it is possible to reduce the effort required to create a web page.

Here, in FIG. 26, as an example, the background of the sub-search words/phrases (for example, “Japan”, “Korea”, “recommendation”, and “ranking”) corresponding to the target search query “makeup” included in each search linking word/phrase is highlighted.

Search linking words/phrases may be displayed in order of the total number of searches or the economic scale. The display aspect (for example, the color of characters and the color of the character background) of each search linking word/phrase may be changed according to the total number of searches or the economic scale.

In the above-described embodiment, a part or all of processing of the terminal 1 may be executed by the computer system 2, or a part or all of processing of the computer system 2 may be executed by the terminal 1. In addition, at least a part of the information processing system S described in the above-described embodiment, specifically, the terminal 1 or the computer system 2 may be configured by hardware or software. In a case where the information processing system S is configured by software, a program for realizing at least some functions of the information processing system S, specifically, the terminal 1 or the computer system 2 may be stored in a computer-readable recording medium and read and executed by a computer. The recording medium is not limited to a removable recording medium such as a magnetic disk or an optical disk, and may be a stationary recording medium such as a hard disk device or a memory.

In addition, a program for realizing at least some functions of the information processing system S, specifically, the terminal 1 or the computer system 2 may be distributed via a communication line (including wireless communication) such as the Internet. Further, the program may be distributed via a wired line or a wireless line such as the Internet or by being stored in a recording medium in an encrypted, modulated, or compressed state.

Furthermore, the computer system 2 may be caused to function by one or a plurality of information apparatuses. In the case of using a plurality of information apparatuses, one of the information apparatuses may be a computer, and the computer may execute a predetermined program to realize a function as at least one means of the information processing system S.

Further, in the invention of the method, all the processes (steps) may be realized by automatic control using a computer. In addition, while causing a computer to perform each process, progress control between processes may be performed manually. Furthermore, at least some of all steps may be performed manually.

As described above, the present invention is not limited to the above-described embodiment as it is, and can be embodied by modifying the components without departing from the gist of the present invention in the implementation stage. In addition, various inventions can be formed by appropriately combining a plurality of components disclosed in the above embodiment. For example, some components may be deleted from all the components shown in the embodiments. Furthermore, components in different embodiments may be appropriately combined.

### REFERENCE SIGNS LIST

1 Terminal
11 Input interface
12 Communication module
13 Storage
14 Memory
15 Output interface
16 Processor
17 Display
2 Computer system
21 Input interface
22 Communication module
23 Storage
24 Memory
25 Output interface
26 Processor
3 Search engine server
4 Sub-search word/phrase server

1. An information processing system comprising a terminal and a computer system,
wherein, in a case where a target search query of web content is received from a user, the terminal or the computer system outputs information for displaying a plurality of sub-search words/phrases used for search together with the target search query in another search query and/or a plurality of contained words/phrases mentioned on web pages up to a predetermined rank in search results of the target search query as a word/phrase list in a tree structure, and
wherein the terminal or the computer system outputs information for displaying a combination of a heading tag assigned according to a hierarchy of each node of the tree structure and a word/phase of the node when a specific operation is executed by the user on a part or all of the displayed tree structure.

2. The information processing system according to claim 1, wherein the terminal or the computer system outputs information for displaying a list of the sub-search words/phrases or a list of the contained words/phrases according to an operation of the user, and
wherein the terminal performs control to add a selected word/phrase to the word/phrase list in accordance with operations of the user to select a word/phrase in the list of the sub-search words/phrases or a word/phrase in the list of the contained words/phrases and to add the selected word/phrase to a target segment.

3. The information processing system according to claim 2, wherein the terminal or the computer system outputs information for displaying a list obtained by sorting the sub-search words/phrases by segments of the sub-search words/phrases, a number of types of search queries including the target search query and the sub-search words/phrases, total numbers of searches or economic scales of search queries including the target search query and the sub-search words/phrases, industry uniqueness of the sub-search words/phrases, generalities of the sub-search words/phrases, a number of web pages in which the sub-search words/phrases appear among top search web pages, or frequencies at which the sub-search words/phrases appear in the top search web pages according to a sorting operation of the user on the list of the sub-search words/phrases.

4. The information processing system according to claim 2, wherein the terminal or the computer system outputs information for displaying a list in which the contained words/phrases are sorted by industry uniqueness of the contained words/phrases, generalities of the contained words/phrases, frequencies at which the contained words/phrases are emphasized, and frequencies at which the contained words/phrases appear on a web page of a specific search rank, according to a sorting operation of the user on the list of the contained words/phrases.

5. The information processing system according to any one of claims 1 to 4, wherein the terminal or the computer system updates the tree structure such that another second word/phrase is added to a child node of a first word/phrase in response to a user operation of adding another second word/phrase to a layer lower than the first word/phrase on a display screen on which a plurality of words/phrases including the first word/phrase and the second word/phrase is displayed.

6. The information processing system according to any one of claims 1 to 5, wherein, when the user selects one parameter from among the number of web pages in which a target word/phrase appears among top search web pages, a content degree of the target word/phrase in the top search web pages, a uniqueness of the target word/phrase, and a total search number or an economic scale of search queries including the target search query and the target word/phrase, the terminal or the computer system performs display control on each word/phrase in the word/phrase list in a display aspect in which a level or an actual number of parameters selected by the user is recognizable.

7. The information processing system according to any one of claims 1 to 6, further comprising at least one storage in which a segment representing a category of a word/phrase is stored in association with each word/phrase,
wherein, upon receiving a target search query of web content from the user, the terminal or the computer system outputs information for displaying the plurality of sub-search words/phrases and/or the plurality of contained words/phrases as a word/phrase list for each segment with reference to the storage.

8. An information processing system comprising at least one processor configured to, in a case where a target search query of web content is received from a user, output information for displaying plurality of sub-search words/phrases used for search together with the target search query in another search query, and search linking words/phrases including the target search query and the sub-search words/phrases such that the search linking words/phrases are associated with the sub-search words/phrases.

9. A terminal comprising at least one processor, wherein
in a case where a target search query of web content is received from a user, the at least one processor causes a plurality of sub-search words/phrases used for search together with the target search query in another search query and/or a plurality of contained words/phrases mentioned on web pages up to a predetermined rank in search results of the target search query to be displayed as a word/phrase list in a tree structure, and
outputs information for displaying a combination of a heading tag assigned according to a hierarchy of each node of the tree structure and a word/phrase of the node when a specific operation by the user is executed on a part of all of the displayed tree structure.

10. An information processing method comprising:
a procedure of outputting, in a case where a target search query of web content is received from a user, information for displaying plurality of sub-search words/phrases used for search together with the target search query in another search query and/or a plurality of contained words/phrases mentioned on web pages up to a predetermined rank in search results of the target search query as a word/phrase list in a tree structure; and
a procedure of outputting information for displaying a combination of a heading tag assigned according to a hierarchy of each node of the tree structure and a word/phrase of the node when a specific operation by the user is executed on a part or all of the displayed tree structure.

11. An information processing method comprising:
a procedure in which, in a case where a target search query of web content is received from a user, at least one processor displays a plurality of sub-search words/phrases used for search together with the target search query in another search query and/or a plurality of contained words/phrases mentioned on web pages up to a predetermined rank in search results of the target search query as a word/phrase list in a tree structure, and
a procedure in which the processor outputs information for displaying a combination of a heading tag assigned according to a hierarchy of each node of the tree structure and a word/phase of the node when a specific operation is executed by the user on a part or all of the displayed tree structure.

12. An information processing method comprising a procedure H outputting, in a case where a target search query of web content is received from a user, information for displaying a word/phrase list obtained by visualizing a plurality of sub-search words/phrases used for search together with the target search query in another search query, and search linking words/phrases including the target search query and the sub-search words/phrases such that the search linking words/phrases are associated with the sub-search words/phrases.

13. A program causing a computer to execute:
a procedure of, in a case where a target search query of web content is received from a user, displaying a plurality of sub-search words/phrases used for search together with the target search query in another search query and/or a plurality of contained words/phrases mentioned on web pages up to a predetermined rank in search results of the target search query as a word/phrase list in a tree structure; and
a procedure of outputting information for displaying a combination of a heading tag assigned according to a hierarchy of each node of the tree structure and a word/phase of the node when a specific operation is executed by the user on a part or all of the displayed tree structure.

14. A program causing a computer to execute a procedure of outputting, in a case where a target search query of web content is received from a user, information for displaying a word/phrase list obtained by visualizing a plurality of sub-search words/phrases used for search together with the target search query in another search query, and search linking words/phrases including the target search query and the sub-search words/phrases such that the search linking words/phrases are associated with the sub-search words/phrases.

15. A data structure having a tree structure used when a terminal comprising a processor displays a plurality of words/phrases in a tree structure,
wherein the data structure has a word/phrase in association with a root node and has a word/phrase in association with each of at least one or more first child nodes associated with the root node, and the first child node is able to further have at least one or more second child nodes and have a word/phrase in association with each of the second child nodes, and
wherein the processor is caused to read the data structure to display words/phrases in the data structure in a tree structure.

16. A data structure used when a terminal comprising a processor displays and/or holds a heading tag of a heading of a web page and a word/phrase in the heading,
wherein the data structure has a word/phrase associated with a heading tag, and
wherein the processor reads the data structure to display a combination of a heading tag and a word/phrase in the data structure.
